(19) United States
(12) Patent Application Publication
(10) Pub. No.: US 2011/0281145 A1
(43) Pub. Date: Nov. 17, 2011

(54) BATTERY THERMAL MANAGEMENT SYSTEMS AND METHODS

(75) Inventor: Broc William TenHouten, Santa Monica, CA (US)

(73) Assignee: CODA AUTOMOTIVE, INC., Santa Monica, CA (US)

(21) Appl. No.: 12/943,595

(22) Filed: Nov. 10, 2010

Related U.S. Application Data
(60) Provisional application No. 61/260,101, filed on Nov. 11, 2009.

(51) Int. Cl. H01M 10/50; H01M 10/42

(52) U.S. Cl. 429/50; 429/120; 429/62

(57) ABSTRACT

Systems and methods for temperature control of a battery pack at, below, or above a target temperature, and/or within a temperature range. Systems and methods for battery pack thermal management having a thermally conductive interstitial member between battery cells and a thermally conductive plate or plates coupled to the interstitial member along which fluid flows to effect the temperature of the battery pack by drawing heat generated by the battery pack away from the battery pack in multiple directions, and/or by imparting heat to the battery pack in multiple directions. Systems and methods for battery pack thermal management having a thermally conductive interstitial member between cells of the battery pack and a plate coupled to the interstitial member along which fluid can flow in multiple directions to maintain the battery pack at, above, or below a target temperature, within a temperature range, and/or to minimize the pack temperature gradient.

### CROSS-REFERENCE

This application claims the benefit of U.S. Provisional Application No. 61/260,101, filed Nov. 11, 2009, which application is incorporated herein by reference.

### BACKGROUND OF THE INVENTION

The number of electric vehicles in 1900 outnumbered gas-powered cars by nearly a factor of two. Nevertheless, the weight of these vehicles, long recharging times, and poor durability, among other factors, reduced the ability of electric vehicles to maintain their market presence. By 1920, electric vehicles had nearly disappeared in lieu of gas-powered vehicles. In the mid 1970s, oil shortages rekindled development of electric vehicle technologies; however, restabilization of the oil markets thereafter resulted in slow progression and market acceptance of electric vehicles. Today, over two thirds of fossil fuel consumption in the United States is used for transportation. A downside of fossil fuel reliance, however, is that the rate at which humans now rely upon and consume fossil fuels for electricity and/or transportation is 100,000 times faster than the rate at which such fuels are created by natural forces. Thus, electric vehicles provide advantages over gas vehicles in terms of reducing pollutants and reducing fossil energy consumption and dependence.

Electric vehicle operation is similar to that of an internal combustion vehicle. The user interface of both vehicles is similar. Both internal combustion and electric vehicles have accelerator pedals, brake pedals, gear selection systems, and steering wheels. The primary difference between the two types of vehicles is that internal combustion vehicles use an engine to provide propulsion by burning fuel contained in a tank, whereas electric vehicles have their propulsion provided by a motor that draws energy from a battery via a motor controller (inverter). Many electric vehicles also employ regenerative braking systems which capture kinetic energy during braking and/or induced coast-down and route the energy through the inverter back to the battery pack.

### SUMMARY OF THE INVENTION

Provided herein is a system for thermal management of a battery pack. The system may be used in an electric vehicle, a hybrid electric vehicle, or in another application that requires a battery pack. In some embodiments, the system comprises: a battery pack comprising a plurality of cells; an interstitial member between at least two cells of the plurality of cells; a plate, which acts as a direct contact heat exchanger that is thermally coupled to the interstitial member; and a flowing fluid capable of transferring heat to or from the battery pack via the thermally conductive chain formed by the plate at the interstitial members, wherein the interstitial member comprises a thermally conductive material, and wherein the direction of the fluid flow may be reversed periodically. In some embodiments, the thermal management cools the battery pack. In some embodiments, the thermal management heats the battery pack. In some embodiments, the thermal management cools at least one cell of the battery pack, and beats at least one cell of the battery pack.

In some embodiments, the plate is adjacent a first surface of the battery pack, and wherein a second plate is adjacent a second surface of the battery pack.

In some embodiments, at least one of the plates comprises the thermally conductive material. In some embodiments, at least one of the plates comprises a plurality of layers of the thermally conductive material.

In some embodiments, the plate cools a plurality of surfaces of the battery pack.

In some embodiments, the system comprises multiple plates on the exterior surfaces of the battery. The plates, in some embodiments, are coupled to the interstitial member(s).

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

In some embodiments, the interstitial member and at least one of the first plate and the second plate are contiguous.

In some embodiments the plate is a multi-pass heat exchanger.

In some embodiments, the plate(s) are complex heat exchangers, which use regenerative heat exchange to promote thermal homogeneity.

Provided herein is a system for thermal management of a battery pack. The system may be used in an electric vehicle, a hybrid electric vehicle, or in another application that requires a battery pack. In some embodiments, the system comprises: a battery pack comprising a plurality of cells; an interstitial member between at least two cells of the plurality of cells; a first plate coupled to the interstitial member; a second plate coupled to interstitial member; and a flowing fluid capable of drawing heat generated by the battery pack from the interstitial member to the first plate and for drawing the heat generated by the battery pack from the interstitial member to the second plate, wherein the interstitial member comprises a thermally conductive material, and wherein the heat is drawn to the first plate in a different direction than the heat is drawn to the second plate. In some embodiments, the system comprises: a battery pack comprising a plurality of cells; an interstitial member between at least two cells of the plurality of cells; a first plate coupled to the interstitial member; a second plate coupled to interstitial member; and a flowing fluid capable of imparting heat from the fluid to the first plate to the interstitial member and to the battery pack and capable of imparting heat from the fluid to the second plate to the interstitial member and to the battery pack; wherein the heat is imparted from the first plate to the battery pack in a different direction than the heat imparted from the second plate to the battery pack. In some embodiments, the thermal management cools the battery pack. In some embodiments, the thermal management heats the battery pack. In some embodiments, the thermal management cools at least one cell of the battery pack, and heats at least one cell of the battery pack.

In some embodiments, at least one of the first plate and the second plate acts as a direct contact heat exchanger between the flowing fluid and the interstitial member. In some embodiments at least one of the first plate and the second plate is a multi-pass heat exchanger.

In some embodiments, the first plate is adjacent a first surface of the battery pack, and wherein the second plate is adjacent a second surface of the battery pack.

In some embodiments, at least one of the first plate and the second plate comprises the thermally conductive material. In some embodiments, at least one of the first plate and the second plate comprises a plurality of layers of the thermally conductive material.

In some embodiments, the first plate and the second plate cool a plurality of surfaces of the battery pack. In some embodiments, the first plate and the second plate heat a plurality of surfaces of the battery pack.

In some embodiments, the system comprises a third plate coupled to the interstitial member.

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

In some embodiments, the interstitial member and at least one of the first plate and the second plate are contiguous.

In some embodiments, at least one of the first plate and the second plate creates thermal homogeneity of the battery pack. In some embodiments, at least one of the first plate and the second plate uses regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. As used herein, the term “degrees Celsius” is interchangeably and synonymous with “C”. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

Provided herein is a system for thermal management of a battery pack comprising: the battery pack comprising a plurality of cells; an interstitial member between at least two cell of the plurality of cells; a first plate coupled to the interstitial member; and a flowing fluid capable of drawing heat generated by the battery pack from the interstitial member to the first plate, wherein the interstitial member comprises a thermally conductive material, and wherein the flowing fluid changes from a first flow direction to a second flow direction.

Provided herein is a system for thermal management of a battery pack comprising: the battery pack comprising a plurality of cells; an interstitial member between at least two cell of the plurality of cells; a first plate coupled to the interstitial member; and a flowing fluid capable of imparting heat to the first plate to the interstitial member and to the battery pack, wherein the interstitial member comprises a thermally conductive material, and wherein the flowing fluid changes from a first flow direction to a second flow direction.

In some embodiments, the plate acts as a direct contact heat exchanger between the flowing fluid and the interstitial member. In some embodiments the plate is a multi-pass heat exchanger. In some embodiments, the thermal management cools the battery pack. In some embodiments, the thermal management heats the battery pack. In some embodiments, the thermal management cools at least one cell of the battery pack, and heats at least one cell of the battery pack.

In some embodiments, the first flow direction is the reverse direction of the second flow direction. In some embodiments, the first flow direction is a different direction than the second flow direction. In some embodiments, the first flow direction is 90 degrees rotated from the second flow direction.

In some embodiments, the system comprises a control element capable of changing the first flow direction to the second flow direction in response to the flowing fluid reaching a predetermined temperature.

In some embodiments, the system comprises a control element capable of changing the first flow direction to the second flow direction at a predetermined interval. In some embodiments, the interval is periodic.

In some embodiments, the flowing fluid changes from the second flow direction to the first flow direction.

In some embodiments, the system comprises a control element capable of changing the second flow direction to the first flow direction in response to the flowing fluid reaching a predetermined temperature. In some embodiments, the system comprises a control element capable of changing the second flow direction to the first flow direction at a predetermined interval.

In some embodiments, the cooling flowing fluid periodically changes from the second flow direction to a third flow direction.

In some embodiments, the system comprises a control element capable of changing at least one of the first flow direction and the second flow direction to a third flow direction. In some embodiments, the change in flow direction is in response to the flowing fluid reaching a predetermined temperature.

In some embodiments, the control element is capable of changing among the first flow direction, the second flow direction and the third flow direction in response to a temperature of at least one cell in the battery pack.

In some embodiments, the system comprises a control element capable of changing among the first flow direction, the second flow direction, a third flow direction, and a fourth flow direction in response to the flowing fluid reaching a predetermined temperature in one of a plurality of predetermined locations.

In some embodiments, the system comprises a control element capable of changing among the first flow direction, the second flow direction, a third flow direction, and a fourth flow direction in response to a temperature of at least one cell in the battery pack.

In some embodiments, the system comprises a control element capable of changing among the first flow direction, the second flow direction, and a third flow direction in response to a hot spot location in the battery pack. In some embodiments, the system comprises a control element capable of changing among the first flow direction, the second flow direction, and a third flow direction in response to a cold spot location in the battery pack.

In some embodiments, the system comprises a control element capable of applying the flowing fluid to the battery pack in an optimal flow direction. In some embodiments, the optimal flow direction is chosen from the first flow direction and the second flow direction. In some embodiments, the optimal flow direction is chosen from the first flow direction, the second flow direction, and a third flow direction. In some embodiments, the optimal flow direction is chosen from the first flow direction, the second flow direction, a third flow direction, and a fourth flow direction. In some embodiments, the optimal flow direction changes over time between the first flow direction and the second flow direction. In some embodiments, the optimal flow direction changes over time between the first flow direction, the second flow direction, and a third flow direction. In some embodiments, the optimal flow direction changes over time between the first flow direction, the second flow direction, a third flow direction, and a fourth flow direction.

In some embodiments, the optimal flow direction is the flow direction that will lower the temperature of a hot spot location in the battery pack. In some embodiments, the optimal flow direction is the flow direction that will lower the temperature of a cell of battery pack. In some embodiments, the optimal flow direction is the flow direction that will lower a temperature of the flowing fluid. In some embodiments, the optimal flow direction is the flow direction that will maintain the entire battery pack below a target temperature.

In some embodiments, the optimal flow direction is the flow direction that will raise the temperature of a cold spot location in the battery pack. In some embodiments, the optimal flow direction is the flow direction that will raise the temperature of a cell of battery pack. In some embodiments, the optimal flow direction is the flow direction that will raise a temperature of the flowing fluid. In some embodiments, the optimal flow direction is the flow direction that will maintain the entire battery pack above a target temperature.

In some embodiments the optimal flow direction is the flow direction that will result in thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

Provided herein is a system for thermal management of a battery pack comprising: the battery pack comprising a plurality of cells; an interstitial member between at least two cell of the plurality of cells; a first plate coupled to the interstitial member; a second plate coupled to interstitial member; and a flowing fluid capable of drawing heat generated by the battery pack from the interstitial member to the first plate and for drawing the heat generated by the battery pack from the interstitial member to the second plate, wherein the interstitial member comprises a thermally conductive material, and wherein the system is capable of flowing the flowing fluid in a first flow direction and in a second flow direction.

Provided herein is a system for thermal management of a battery pack comprising: the battery pack comprising a plurality of cells; an interstitial member between at least two cell of the plurality of cells; a first plate coupled to the interstitial member; a second plate coupled to interstitial member; and a flowing fluid capable of imparting heat from the flowing fluid to the first plate to the interstitial member and to the battery pack, and for imparting heat from the flowing fluid to the second plate to the interstitial member, and to the battery pack, wherein the interstitial member comprises a thermally conductive material, and wherein the system is capable of flowing the flowing fluid in a first flow direction and in a second flow direction.

In some embodiments, the thermal management cools the battery pack. In some embodiments, the thermal management heats the battery pack. In some embodiments, the thermal management cools at least one cell of the battery pack, and heats at least one cell of the battery pack.

In some embodiments, the system is capable of flowing the flowing fluid in the first flow direction and in the second flow direction at the same time. In some embodiments, the first flow direction and the second flow direction are different directions. In some embodiments, the system comprises a control element that is capable of changing in the flow direction of the flowing fluid from the first flow direction to the second flow direction, and from the second flow direction to the first flow direction.

In some embodiments, at least one of the first plate and the second plate acts as a direct contact heat exchanger between the flowing fluid and the interstitial member. In some embodiments at least one of the first plate and the second plate is a multi-pass heat exchanger.

In some embodiments, changing the flow direction is in response to at least one of: a predetermined time interval, the flowing fluid reaching a predetermined temperature, the flowing fluid reaching a predetermined temperature in one of a plurality of predetermined locations, a temperature of at least one cell in the battery pack, a cold spot location in the battery pack, a hot spot location in the battery pack, and a battery pack temperature gradient.

In some embodiments, the control element is capable of changing among the first flow direction, the second flow direction and the third flow direction in response to at least one of: a predetermined time interval, the flowing fluid reaching a predetermined temperature, the flowing fluid reaching a predetermined temperature in one of a plurality of predetermined locations, a temperature of at least one cell in the battery pack, a cold spot location in the battery pack, a hot spot location in the battery pack, and a battery pack temperature gradient.

Some embodiments of the system provided herein comprise a control element capable of changing among the first flow direction, the second flow direction, a third flow direction, and a fourth flow direction in response to at least one of: a predetermined time interval, the flowing fluid reaching a predetermined temperature, the flowing fluid reaching a predetermined temperature in one of a plurality of predetermined locations, a temperature of at least one cell in the battery pack, a cold spot location in the battery pack, a hot spot location in the battery pack, and a battery pack temperature gradient.

In some embodiments, the control element is capable of applying the flowing fluid to the battery pack in an optimal flow direction. In some embodiments, the optimal flow direction is chosen from the first flow direction and the second flow direction. In some embodiments, the optimal flow direction is chosen from the first flow direction, the second flow direction, and a third flow direction. In some embodiments, the optimal flow direction is chosen from the first flow direction, the second flow direction, a third flow direction, and a fourth flow direction. In some embodiments, the optimal flow direction changes over time.

In some embodiments, the optimal flow direction is the flow direction that will at least one of lower the temperature of a hot spot location in the battery pack, lower the temperature of a cell of battery pack, lower a temperature of the flowing fluid, and maintain the entire battery pack below a target temperature.

In some embodiments, the optimal flow direction is the flow direction that will raise the temperature of a cold spot location in the battery pack. In some embodiments, the optimal flow direction is the flow direction that will raise the temperature of a cell of battery pack. In some embodiments, the optimal flow direction is the flow direction that will raise a temperature of the flowing fluid. In some embodiments, the optimal flow direction is the flow direction that will maintain the entire battery pack above a target temperature.

In some embodiments the optimal flow direction is the flow direction that will result in thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the optimal flow direction can change between at least the first flow direction and the second flow direction in order to: lower the temperature of a hot spot location in the battery pack, lower the temperature of a cell of battery pack, lower a temperature of the flowing fluid, maintain the entire battery pack within a temperature gradient, and/or maintain the entire battery pack below a target temperature.

In some embodiments, the optimal flow direction can change between at least the first flow direction and the second flow direction in order to: raise the temperature of a cold spot location in the battery pack, raise the temperature of a cell of battery pack, raise a temperature of the flowing fluid, maintain the entire battery pack within a temperature gradient, and/or maintain the entire battery pack above a target temperature.

Provided herein is a method for thermal management of a battery pack comprising: providing the battery pack comprising a plurality of cells and an interstitial member between at least two cell of the plurality of cells; providing a plurality of plates coupled to the interstitial member; flowing a cooling fluid along the plurality of plates; drawing heat generated by the battery pack in a first direction from the interstitial member to a first plate of the plurality of plates; and drawing heat generated by the battery pack in a second direction from the interstitial member to a second plate of the plurality of plates, wherein the interstitial member comprises a thermally conductive material, and wherein the first direction is a different direction than the second direction.

Provided herein is a method for thermal management of a battery pack comprising: providing the battery pack comprising a plurality of cells and an interstitial member between at least two cell of the plurality of cells; providing a plurality of plates coupled to the interstitial member; flowing a fluid along the plurality of plates; wherein the control element is capable of imparting heat in a first direction from the fluid to a first plate of the plurality of plates, to the interstitial member, and to the battery pack, wherein the control element is capable of imparting heat in a second direction from the fluid to a second plate of the plurality of plates, to the interstitial member, and to the battery pack, wherein the interstitial member comprises a thermally conductive material, and wherein the first direction is a different direction than the second direction.

In some embodiments, the thermal management cools the battery pack. In some embodiments, the thermal management heats the battery pack. In some embodiments, the thermal management cools at least one cell of the battery pack, and heats at least one cell of the battery pack.

In some embodiments, the method comprises placing the first plate adjacent a first surface of the battery pack, and placing the second plate adjacent a second surface of the battery pack.

In some embodiments, at least one of the first plate and the second plate comprises the thermally conductive material. In some embodiments, at least one of the first plate and the second plate comprises a plurality of layers of the thermally conductive material.

In some embodiments, at least one of the first plate and the second plate acts as a direct contact heat exchanger between the flowing fluid and the interstitial member. In some embodiments at least one of the first plate and the second plate is a multi-pass heat exchanger.

In some embodiments, the method comprises drawing heat generated by the battery pack in a third direction from the interstitial member to a third plate of the plurality of plates.

In some embodiments, the method comprises imparting heat in a third direction from the fluid to a third plate of the plurality of plates to the interstitial member to the battery pack.

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

In some embodiments, the interstitial member and at least one of the first plate and the second plate are contiguous.

In some embodiments the optimal flow direction is the flow direction that will result in thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

Provided herein is a method for thermally managing a battery pack comprising: providing the battery pack comprising a plurality of cells and an interstitial member comprising a thermally conductive material between at least two cell of the plurality of cells; providing a first plate coupled to the interstitial member; drawing heat generated by the battery pack from the interstitial member to the first plate wherein drawing the heat comprises flowing a cooling fluid along the first plate in a first flow direction, and flowing the cooling fluid along the first plate in a second flow direction.

Provided herein is a method for thermally managing a battery pack comprising: providing the battery pack comprising a plurality of cells and an interstitial member comprising a thermally conductive material between at least two cells of the plurality of cells; providing a first plate coupled to the interstitial member; imparting heat to the battery pack from the interstitial member and from the first plate wherein imparting the heat comprises flowing a warming fluid along the first plate in a first flow direction, and flowing the warming fluid along the first plate in a second flow direction.

Provided herein is a method for thermally managing a battery pack comprising: providing the battery pack comprising a plurality of cells and an interstitial member comprising a thermally conductive material between at least two cells of the plurality of cells; providing a first plate coupled to the interstitial member; providing a control element capable of imparting heat to the battery pack from the interstitial member by flowing a fluid along the first plate in a first flow direction, and flowing the fluid along the first plate in a second flow direction.

In some embodiments, the first plate is on multiple surfaces of the battery pack.

In some embodiments, the first flow direction is the reverse direction of the second flow direction.

In some embodiments, flowing a cooling fluid along the first plate in a first flow direction, and flowing the cooling fluid along the first plate in a second flow direction is done simultaneously.

In some embodiments, flowing a cooling fluid along the first plate in a first flow direction, and flowing the warming fluid along the first plate in a second flow direction is done simultaneously.

In some embodiments, the first flow direction is a different direction than the second flow direction.

In some embodiments, the first flow direction is 90 degrees rotated from the second flow direction.

In some embodiments, the method comprises changing the second flow direction to the first flow direction. In some embodiments, the method comprises changing between the first flow direction and the second flow direction in response to at least one of a predetermined time interval, the cooling fluid reaching a predetermined temperature, the warming fluid reaching a predetermined temperature, the cooling fluid reaching a predetermined temperature at a predetermined location, the cooling fluid reaching a predetermined temperature at one of a plurality of predetermined locations, a temperature of at least one cell in the battery pack, a hot spot location in the battery pack, the warming fluid reaching a predetermined temperature at a predetermined location, the warming fluid reaching a predetermined temperature at one of a plurality of predetermined locations, the battery pack temperature gradient, and a cold spot location in the battery pack. In some embodiments, the interval is periodic.

In some embodiments the optimal flow direction is the flow direction that will result in thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

In some embodiments, the first plate acts as a direct contact heat exchanger between the flowing fluid and the interstitial member. In some embodiments the first plate is a multi-pass heat exchanger.

In some embodiments, the method comprises changing at least one of the first flow direction and the second flow direction to a third flow direction. In some embodiments, the method comprises changing among the first flow direction, the second flow direction, and a third flow direction in response to at least one of: a predetermined time interval, the cooling fluid reaching a predetermined temperature, the cooling fluid reaching a predetermined temperature at a predetermined location, the cooling fluid reaching a predetermined temperature at one of a plurality of predetermined locations, a temperature of at least one cell in the battery pack, a hot spot location in the battery pack, the warming fluid reaching a predetermined temperature, the warming fluid reaching a predetermined temperature at a predetermined location, the warming fluid reaching a predetermined temperature at one of a plurality of predetermined locations, a battery pack temperature gradient, and a cold spot location in the battery pack.

In some embodiments, the method comprises changing among the first flow direction, the second flow direction, a third flow direction, and a fourth flow direction in response to at least one of: a predetermined time interval, the cooling fluid reaching a predetermined temperature, the cooling fluid reaching a predetermined temperature at a predetermined location, the cooling fluid reaching a predetermined temperature at one of a plurality of predetermined locations, a temperature of at least one cell in the battery pack, a hot spot location in the battery pack, the warming fluid reaching a predetermined temperature, the warming fluid reaching a predetermined temperature at a predetermined location, the warming fluid reaching a predetermined temperature at one of a plurality of predetermined locations, a battery pack temperature gradient, and a cold spot location in the battery pack.

In some embodiments, the method comprises providing a second plate coupled to the interstitial member.

In some embodiments, flowing the cooling fluid in the first flow direction flows the cooling fluid along the second plate in the first flow direction. In some embodiments, flowing the cooling fluid in the second flow direction flows the cooling fluid along the second plate in the second flow direction. In some embodiments, flowing the cooling fluid in the first flow direction flows the cooling fluid along the first plate and the second plate in the first flow direction. In some embodiments, flowing the cooling fluid in the second flow direction flows the cooling fluid along the first plate and the second plate in the second flow direction. In some embodiments, flowing the cooling fluid in the first flow direction flows the cooling fluid along the first plate in the second flow direction, and flowing the cooling fluid in the second flow direction flows the cooling fluid along the second plate in the second flow direction.

In some embodiments, flowing the warming fluid in the first flow direction flows the warming fluid along the second plate in the first flow direction. In some embodiments, flowing the warming fluid in the second flow direction flows the warming fluid along the second plate in the second flow direction. In some embodiments, flowing the warming fluid in the first flow direction flows the warming fluid along the first plate and the second plate in the first flow direction. In some embodiments, flowing the warming fluid in the second flow direction flows the cooling fluid along the first plate and the second plate in the second flow direction. In some embodiments, flowing the warming fluid in the first flow direction flows the warming fluid along the first plate in the second flow direction, and flowing the warming fluid in the second flow direction flows the warming fluid along the second plate in the second flow direction.

Provided herein is a method for thermal management of a battery pack comprising: providing the battery pack comprising a plurality of cells and an interstitial member comprising a thermally conductive material between at least two cell of the plurality of cells; providing a first plate coupled to the interstitial member; drawing heat generated by the battery pack from the interstitial member to the first plate wherein drawing the heat comprises determining an optimal cooling fluid flow direction, and flowing the cooling fluid along the first plate in the optimal flow direction.

Provided herein is a method for thermal management of a battery pack comprising: providing the battery pack comprising a plurality of cells and an interstitial member comprising a thermally conductive material between at least two cell of the plurality of cells; providing a first plate coupled to the interstitial member; imparting heat to the battery pack from the interstitial member from the first plate wherein imparting the heat comprises determining an optimal warming fluid flow direction, and flowing the warming fluid along the first plate in the optimal flow direction.

In some embodiments, the thermal management cools the battery pack. In some embodiments, the thermal management heats the battery pack. In some embodiments, the thermal management cools at least one cell of the battery pack, and heats at least one cell of the battery pack.

In some embodiments, the first plate acts as a direct contact heat exchanger between the flowing fluid and the interstitial member. In some embodiments the first plate is a multi-pass heat exchanger.

In some embodiments, drawing heat comprises determining which of a first flow direction and a second flow direction is the optimal flow direction. In some embodiments, imparting heat comprises determining which of a first flow direction and a second flow direction is the optimal flow direction. In some embodiments, the optimal flow direction is chosen from a first flow direction and a second flow direction. In some embodiments, the optimal flow direction is chosen from a first flow direction, a second flow direction, and a third flow direction. In some embodiments, the optimal flow direction is chosen from a first flow direction, a second flow direction, a third flow direction, and a fourth flow direction.

In some embodiments, the optimal flow direction is the flow direction that will at least one of: lower the temperature of a hot spot location in the battery pack, lower the temperature of a cell of battery pack, lower a temperature of the flowing fluid, and maintain the entire battery pack below a target temperature. In some embodiments, the optimal flow direction is the flow direction that will at least one of: raise the temperature of a cold spot location in the battery pack, raise the temperature of a cell of battery pack, raise a temperature of the flowing fluid, and maintain the entire battery pack above a target temperature. In some embodiments, the optimal flow direction is the flow direction that will maintain the battery pack within a temperature range.

In some embodiments, the optimal flow direction can change between a first flow direction and a second flow direction in order to at least one of: lower the temperature of a hot spot location in the battery pack, lower the temperature of a cell of battery pack, lower a temperature of the flowing fluid, and maintain the entire battery pack below a target temperature. In some embodiments, the optimal flow direction can change between a first flow direction and a second flow direction in order to at least one of: raise the temperature of a cold spot location in the battery pack, raise the temperature of a cell of battery pack, raise a temperature of the flowing fluid, and maintain the entire battery pack above a target temperature. In some embodiments, the optimal flow direction can change between a first flow direction and a second flow direction in order to maintain the battery pack within a temperature range.

In some embodiments, the optimal flow direction can change among a first flow direction, a second flow direction, and a third flow direction in order to at least one of: lower the temperature of a hot spot location in the battery pack, lower the temperature of a cell of battery pack, lower a temperature of the flowing fluid, and maintain the entire battery pack below a target temperature. In some embodiments, the optimal flow direction can change among a first flow direction, a second flow direction, and a third flow direction in order to at least one of raise the temperature of a cold spot location in the battery pack, raise the temperature of a cell of battery pack, raise a temperature of the flowing fluid, and maintain the entire battery pack above a target temperature. In some embodiments, the optimal flow direction can change among a first flow direction, a second flow direction, and a third flow direction in order to maintain the battery pack within a temperature range.

In some embodiments, the optimal flow direction can change among a first flow direction, a second flow direction, a third flow direction, and a fourth flow direction in order to at least one of: lower the temperature of a hot spot location in the battery pack, lower the temperature of a cell of battery pack, lower a temperature of the flowing fluid, and maintain the entire battery pack below a target temperature. In some embodiments, the optimal flow direction can change among a first flow direction, a second flow direction, a third flow direction, and a fourth flow direction in order to at least one of: raise the temperature of a cold spot location in the battery pack, raise the temperature of a cell of battery pack, raise a temperature of the flowing fluid, and maintain the entire battery pack above a target temperature. In some embodiments, the optimal flow direction can change among a first flow direction, a second flow direction, a third flow direction, and a fourth flow direction in order to maintain the battery pack within a temperature range.

In some embodiments, the optimal flow direction can be a first flow direction along a first side of the battery pack, and at the same time be a second flow direction along a second side of the battery pack, and said optimal flow direction can be chosen in order to at least one of: lower the temperature of a hot spot location in the battery pack, lower the temperature of a cell of battery pack, lower a temperature of the flowing fluid, and maintain the entire battery pack below a target temperature. In some embodiments, the optimal flow direction can be a first flow direction along a first side of the battery pack, and at the same time be a second flow direction along a second side of the battery pack, and said optimal flow direction can be chosen in order to at least one of raise the temperature of a cold spot location in the battery pack, raise the temperature of a cell of battery pack, raise a temperature of the flowing fluid, and maintain the entire battery pack above a target temperature. In some embodiments, the optimal flow direction can be a first flow direction along a first side of the battery pack, and at the same time be a second flow direction along a second side of the battery pack, and said optimal flow direction can be chosen in order to maintain the battery pack within a temperature range.

In some embodiments, the optimal flow direction can be a first flow direction along the first plate, and at the same time be a second flow direction along a second plate coupled to the interstitial member, and said optimal flow direction can be chosen in order to at least one of: lower the temperature of a hot spot location in the battery pack, lower the temperature of a cell of battery pack, lower a temperature of the flowing fluid, and maintain the entire battery pack below a target temperature. In some embodiments, the optimal flow direction can be a first flow direction along the first plate, and at the same time be a second flow direction along a second plate coupled to the interstitial member, and said optimal flow direction can be chosen in order to at least one of: raise the temperature of a hot spot location in the battery pack, raise the temperature of a cell of battery pack, raise a temperature of the flowing fluid, and maintain the entire battery pack above a target temperature. In some embodiments, the optimal flow direction can be a first flow direction along the first plate, and at the same time be a second flow direction along a second plate coupled to the interstitial member, and said optimal flow direction can be chosen in order to maintain the battery pack within a temperature range.

In some embodiments the optimal flow direction is the flow direction that will result in thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings of which:

FIG. 1 depicts a battery pack having an interstitial member between the cells of the pack that is coupled to a plate along a bottom surface of the cells and along which a fluid (a cooling fluid and/or a warming fluid) flows.

FIG. 2 depicts a battery pack having an interstitial member between the cells of the pack that is coupled to a plurality of plates (a first plate on the bottom of the pack, a second plate along a first side of the pack, and a third plate along a second side of the pack), and having fluid (cooling fluid and/or a warming fluid) flowing along each of the plates.

FIG. 3 depicts a chart showing the temperature gradient of a battery pack in which cooling fluid flows in a single direction, which may exhibit a higher temperature than a target temperature at the end of the fluid path.

FIG. 4 depicts a chart showing the temperature gradient of a battery pack in which cooling fluid flows in a single direction which is opposite (or reversed) as compared to that depicted in FIG. 3, which may be exhibit a higher temperature than a target temperature at the end of the fluid path.

FIG. 5 depicts a chart showing the temperature gradient of a battery pack in which cooling fluid alternates flow between a first direction and a second direction (which is the reverse direction of the first direction) which may result in a peak temperature in about the center of the flow path, but which can maintain the entire pack temperature below a target temperature and/or within a battery pack temperature gradient.

FIG. 6 chart showing the temperature gradient of a battery pack in which fluid flows (either simultaneously, in part simultaneously, or alternating depending on the embodiment) along the pack in a plurality of directions, including a first flow direction and a second flow direction which is the reverse of the first flow direction.

FIGS. 7a and 7b depict a battery pack in which fluid (cooling fluid and/or warming fluid) flows along the pack in a plurality of directions, including a first flow direction, a second flow direction which is the reverse of the first flow direction, a third flow direction which is generally orthogonal to at least one of the first flow direction and the second flow direction, and a fourth flow direction which is the reverse of the third flow direction.

FIG. 8 chart showing the temperature gradient of a battery pack in which cooling fluid flows (either simultaneously, in part simultaneously, or alternating depending on the embodiment) along the pack in a plurality of directions, including a first flow direction, a second flow direction which is the reverse of the first flow direction, a third flow direction which is generally orthogonal to at least one of the first flow direction and the second flow direction, and a fourth flow direction which is the reverse of the third flow direction.

### DETAILED DESCRIPTION OF THE INVENTION

Electric vehicle batteries (or battery packs) are comprised of multiple cells. The operating temperature of the cells within the battery pack directly impacts the performance of the battery pack, and also directly impacts the aging characteristics of the cells. Environmental factors and current based internal self-heating of the battery pack both contribute to temperature changes within the pack (or battery pack).

In order to ensure consistent performance and aging throughout the pack, it is critical to control battery pack temperature and minimize temperature gradients within the pack. Thermal control of the average temperature and of the pack thermal gradient is important during both cooling and heating.

When cooling an object (or heat exchanger) with a cooling fluid, heat is transferred to the fluid as it moves across that object (through the coolant path). Heat transfer to the fluid is driven by the temperature difference between the object to be cooled and the fluid. As fluid flows across the object and the fluid absorbs heat, the fluid increases in temperature. When heating an object with a warming fluid, heat is transferred from the fluid to the object as it moves across that object (through the heating path). Heat transfer from the fluid to the object is driven by the temperature difference between the object to be heated and the fluid. As fluid flows across the object and the object absorbs heat, the fluid decreases in temperature and the object increases in temperature.

In unidirectional cooling, a temperature gradient is crated in the fluid. The coolant at the start of the cooling path is lower than the temperature at the outlet. The cooling fluid gradient causes cooling to be more effective at the start of the cooling path than at the end of the path.

The same temperature gradient phenomenon exists when using a thermal fluid to heat an object. As the fluid flows along the path, it cools as the heat exchanger/object accepts heat. This causes the heating at the end of the path to be less effective.

In order to maintain cells within optimal working conditions, it is important to design thermal management systems that control the temperature of the battery pack without creating significant thermal gradients within the pack.

Components of an electric vehicle may include a vehicle body, a frame, a cabling system, a regenerative braking system, an electric motor, an ECM (electronic control module), a traction battery, a battery management system, a smart battery charger, fluids for cooling, braking, etc., and lubricants. The electric vehicle is propelled by an electric motor, which is controlled by the ECM. A traction battery of an electric vehicle may comprise a battery pack, which may comprise a plurality of cells (battery cells). In some embodiments, a battery pack may comprise a single cell. In some embodiments, the cells are grouped together into a single mechanical and electrical unit called a battery module, which are then connected electronically to form a battery pack.

As used herein the term “battery,” may be used synonymously with the term “battery pack” and/or “pack.” As used herein, the term “battery cell” may be used synonymously with the term “cell.”. The term “cell” may represent an element within a battery pack that is a single electrical unit connected electrically with other of the same elements to form the battery pack.

As used and provided herein, the same devices and methods that are described as drawing heat from a cell or from the battery pack may alternatively be used to impart heat to the cell or to the battery pack, such as where the fluid is at a higher temperature than the cell (or at a higher temperature than the battery pack and/or at a higher temperature than the plate coupled to the interstitial member between the cells). Thermal conduction will work in either instance to attempt to equilibrate the temperature differences and, thus, a system described herein as drawing heat from a cell to a plate to the fluid may also be used to heat a cell if the temperature of the fluid is greater than the temperature of the cell (or the temperature of the plate coupled to the interstitial member between the cells). It is intended that although written to describe the cooling of cells (or, alternatively to describe heating of cells), that embodiments may also or alternatively heat the cells by increasing the temperature of the fluid above that of the cell (or cells) to be heated (or above that of the plate coupled to the interstitial member between the cells to be heated). Additionally, since there is typically a temperature gradient among cells in a battery pack, a fluid that heats certain cells (by heating the plate and the interstitial member coupled thereto) may cool other cells (by cooling the plate and the interstitial member coupled thereto), and it is intended that this be the case for embodiments described herein.

A battery cell typically comprises two terminals (one negative, one positive), and an electrolyte that can be a liquid, gel, paste, resin, or solid material, for example. The electrolyte may be acidic or alkaline, for example. The battery cell may be a lead-acid (such as flooded, Deep cycle, and valve-regulated lead-acid (VILLA)), nickel-cadmium (NiCd), Nickel metal hydride (NiMH), Lithium-ion, Lithium-ion polymer, Zinc-air, molten salt, or another type of battery cell.

Provided herein is a system for thermal management of a battery pack. The system may be used in an electric vehicle, a hybrid electric vehicle, or in another application that requires a battery pack. In some embodiments, the system comprises: a battery pack comprising a plurality of cells; an interstitial member between at least two cells of the plurality of cells; a plate, which acts as a direct contact heat exchanger that is thermally coupled to the interstitial member; and a flowing fluid capable of transferring heat to or from the battery pack via the thermally conductive chain formed by the plate at the interstitial members, wherein the interstitial member comprises a thermally conductive material, and wherein the direction of the fluid flow may be reversed periodically.

In some embodiments, the thermal management cools the battery pack. In some embodiments, the thermal management heats the battery pack. In some embodiments, the thermal management cools at least one cell of the battery pack, and heats at least one cell of the battery pack.

In some embodiments, the plate is adjacent a first surface of the battery pack, and wherein a second plate is adjacent a second surface of the battery pack.

In some embodiments, at least one of the plates comprises the thermally conductive material. In some embodiments, at least one of the plates comprises a plurality of layers of the thermally conductive material.

In some embodiments, the plate cools a plurality of surfaces of the battery pack.

In some embodiments, the system comprises multiple plates on the exterior surfaces of the battery. The plates, in some embodiments, are coupled to the interstitial member(s).

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 min and 4 mm thick.

In some embodiments, the interstitial member and at least one of the first plate and the second plate are contiguous.

In some embodiments the plate is a multi-pass heat exchanger.

In some embodiments, the plate(s) are complex heat exchangers, which use regenerative heat exchange to promote thermal homogeneity.

Provided herein is a system for thermal management a battery pack. The system may be used in an electric vehicle, or in another application that requires a battery pack. The cells of the pack, in some embodiments, are placed next to one another in the pack. In some embodiments, a battery pack may comprise a single battery cell. An interstitial member comprising a thermally conductive material may be placed between at least the two of the battery cells (or cells, or modules, or along side a single battery cell of the battery pack) in order to conduct the heat to a cooled layer (or plate). In some embodiments, the interstitial member conducts heat from the plate to the cell (or cells, or modules). The thermally conductive material of the interstitial member and the plate may be made out of thin aluminum sheets (foil), for example. Other thermally conductive materials may additionally or alternatively be used. In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

The plate may be a single piece, or layered, or another configuration altogether (such as mesh, webbed, non-solid, perforated, or any such configuration), so long as it is capable of drawing heat (by conduction) from the interstitial member to the cooling fluid which may be a gas such as air or another gas (e.g. a non-combustible gas), or which may be a liquid. Likewise, in embodiments wherein the cells are to be warmed, the plate may be a single piece, or layered, or another configuration altogether (such as mesh, webbed, non-solid, perforated, or any such configuration), so long as it is capable of imparting heat (by conduction) to the interstitial member from the warming fluid which may be a gas such as air or another gas (e.g. a non-combustible gas), or which may be a liquid. In some embodiments, the plate may be a layered surface comprising the thermally conductive material. The plate, in some embodiments, may be made by having the thermally conductive material be taller than the cell and bending each sheet in the same direction at the base of the cell. In this configuration, no fluid passes between the cells. In such a configuration, the plate is contiguous with the interstitial member, however, other ways for providing a plate that is contiguous with the interstitial member are contemplated herein (or coupled in a manner that prevents fluid from passing between the cells).

In some embodiments, the thermal management cools the battery pack. In some embodiments, the thermal management heats the battery pack. In some embodiments, the thermal management cools at least one cell of the battery pack, and heats at least one cell of the battery pack.

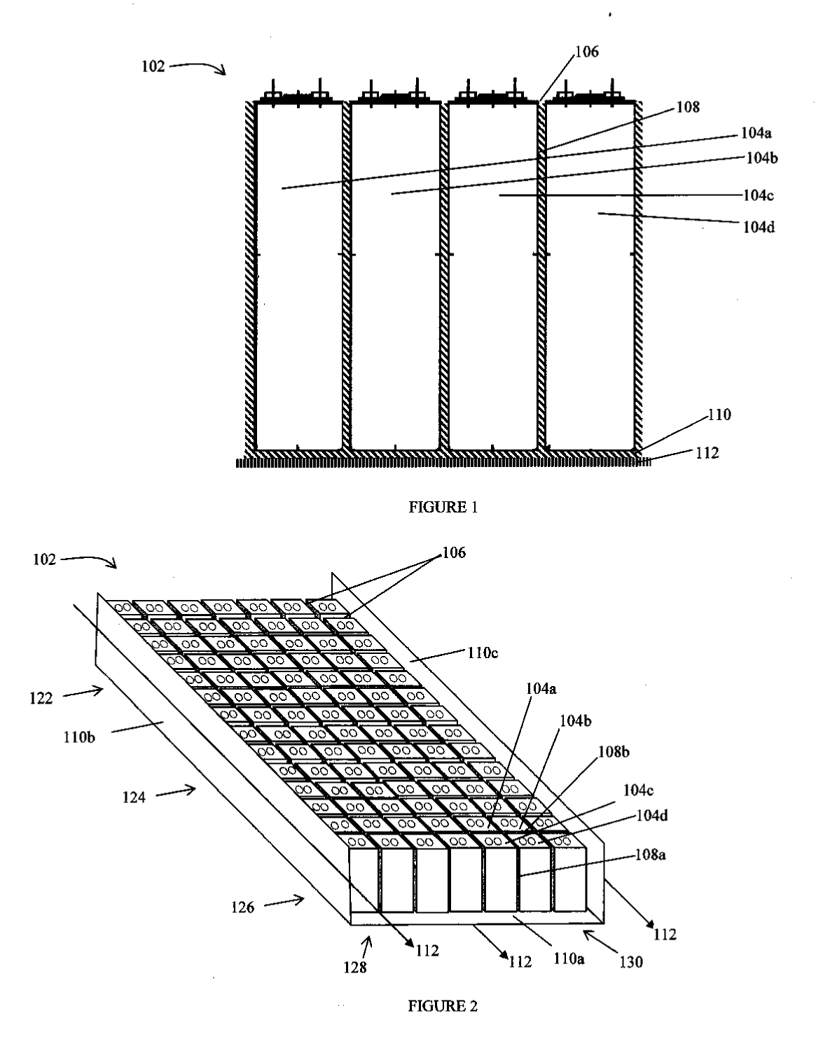

FIG. 1 depicts a battery pack 102 having an interstitial member 108 between the battery cells 104a, 104b, 104c, 104d of the battery pack 102 that is coupled to a plate 110 along a bottom surface of the battery cells 104a, 104b, 104c, 104d and along which a cooling fluid 112 flows. The cells 104a, 104b, 104c, 104d are separated by an interstitial member 108 that is thermally conductive. The interstitial member may touch adjacent cells, for example adjacent cells 104a, 104b, adjacent cells 104b, 104c, and/or adjacent cells 1040, 104d, and/or it may touch one cell 104a of two adjacent cells. The interstitial member 108 may be separated from the cells by a gap of interstitial space 106. The interstitial member 108 may fill at least a portion of the interstitial space 106 between adjacent cells. The interstitial member 108 may be in the interstitial space 106 between a cell 104b and one or more adjacent cells 104a, 104e. The interstitial member 108 may be in the interstitial space 106 adjacent several surfaces of a cell. The interstitial member 108 may be in the interstitial space 106 a surface of a cell and another structure adjacent the cell, which may or may not be an adjacent cell.

The plate 110 may also be thermally conductive, and along the plate a cooling fluid 112 (also called a flowing fluid, and/or a cooling flowing fluid, and/or a cooling fluid, and/or a warming fluid, and or fluid) flows. In some embodiments, a flowing fluid is a fluid that is capable of flowing. Likewise, in some embodiments, a cooling flowing fluid is a fluid that is capable of flowing and is capable of cooling at least one cell of the battery pack. In some embodiments, a cooling fluid is a fluid that is capable of cooling at least one cell of the battery pack. Likewise, in some embodiments, a warming flowing fluid is a fluid that is capable of flowing and is capable of warming at least one cell of the battery pack. The fluid (whether called a flowing fluid or otherwise), need not actually flow to impart heat or to draw heat from the battery pack, although it may, so long as there is a temperature differential between the fluid and the battery pack (or a portion thereof). The fluid 112 in some embodiments does not flow between the cells 104a, 104b, 104c, 104d of the battery pack 102, such as is depicted in the embodiment shown in FIG. 1. The fluid 112 can flow in a plurality of directions, at the same time or at different times. Nevertheless, there may be interstitial space 106 between the cells not filled by the interstitial member 108 and also not filled with the fluid 112, in some embodiments. In some embodiments, the interstitial space 106 is filled by the interstitial member 108, at least partially.

### Multi-Cooled Surfaces

In certain embodiments provided herein, the heat is conducted to the cooling layer at a surface of the cells (cells 104a, 104b, 104c, 104d), such as the base of the cells 104a, 104b, 104c, 104d as depicted in FIG. 1, for example. The layer may be on any side of the set of cells (i.e. the battery pack 102), or even on top. There may be more than one cooling/warming surface (i.e. more than one plate). By having more than one cooling/warming surface (or plate), the thermal gradient across the cells may be reduced or maintained within a desired range (temperature range, or optimal temperature range).

Provided herein is a system for thermal management of a battery pack. In some embodiments, a battery pack may comprise a single cell. In some embodiments, a battery pack may comprise a plurality of cells. The system may be used in an electric vehicle, a hybrid electric vehicle, or in another application that requires a battery pack. The system may comprise a battery pack comprising a plurality of cells; an interstitial member between at least two cell of the plurality of cells; a first plate coupled to the interstitial member; a second plate coupled to interstitial member; and a flowing fluid capable of drawing heat generated by the battery pack from the interstitial member to the first plate and for drawing the heat generated by the battery pack from the interstitial member to the second plate, wherein the interstitial member comprises a thermally conductive material, and wherein the heat is drawn to the first plate in a different direction than the heat is drawn to the second plate. In some embodiments, a flowing fluid is a fluid that is capable of flowing.

In some embodiments, the system comprises: a battery pack comprising a plurality of cells; an interstitial member between at least two cells of the plurality of cells; a first plate coupled to the interstitial member; a second plate coupled to interstitial member; and a flowing fluid capable of imparting heat from the fluid to the first plate to the interstitial member and to the battery pack and capable of imparting heat from the fluid to the second plate to the interstitial member and to the battery pack; wherein the heat is imparted from the first plate to the battery pack in a different direction than the heat imparted from the second plate to the battery pack. In some embodiments, the thermal management cools the battery pack. In some embodiments, the thermal management heats the battery pack. In some embodiments, the thermal management cools at least one cell of the battery pack, and heats at least one cell of the battery pack.

In some embodiments, the system comprises a battery pack comprising a plurality of cells; an interstitial member between at least two cell of the plurality of cells, the interstitial member comprising a thermally conductive material; a first plate coupled to the interstitial member; a second plate coupled to interstitial member; and a flowing fluid capable of drawing heat generated by the battery pack from the interstitial member to the first plate and for drawing the heat generated by the battery pack from the interstitial member to the second plate, wherein the heat is drawn to the first plate in a different direction than the heat is drawn to the second plate.

In some embodiments, at least one of the first plate and the second plate acts as a direct contact heat exchanger between the flowing fluid and the interstitial member. In some embodiments at least one of the first plate and the second plate is a multi-pass heat exchanger.

Provided herein is a system for cooling a cell of a battery pack. In some embodiments, a battery pack may comprise a single cell. In some embodiments, a battery pack may comprise a plurality of cells. The system may be used in an electric vehicle, a hybrid electric vehicle, or in another application that requires a battery pack. The system comprises a battery pack comprising an interstitial member between at least a cell of the battery pack and a structure adjacent the cell that may or may not be a second battery. The system comprises a first plate coupled to the interstitial member; a second plate coupled to the interstitial member; and a control element capable of flowing a first fluid to draw heat generated by the battery pack from the interstitial member to the first plate and capable of flowing the first fluid (or a second fluid) to draw the heat generated by the battery pack from the interstitial member to the second plate. In some embodiments, the system comprises a channel along the first plate through which a fluid may be directed to flow to draw heat generated by the battery pack from the interstitial member to the first plate. In some embodiments, the system comprises a channel along the second plate through which a fluid may be directed to flow to draw heat generated by the battery pack from the interstitial member to the second plate. The interstitial member may comprise a thermally conductive material. The heat may be drawn to the first plate in a different direction than the heat is drawn to the second plate. In some embodiments, a flowing fluid is a fluid that is capable of flowing.

Provided herein is a method for thermal management of a battery pack comprising: providing the battery pack comprising a plurality of cells and an interstitial member between at least two cell of the plurality of cells; providing a plurality of plates coupled to the interstitial member, flowing a fluid along the plurality of plates; imparting heat in a first direction from the fluid to a first plate of the plurality of plates to the first plate, to the interstitial member, and to the battery pack; and imparting heat in a second direction from the fluid to a second plate of the plurality of plates, to the interstitial member, and to the battery pack, wherein the interstitial member comprises a thermally conductive material, and wherein the first direction is a different direction than the second direction. In some embodiments, the system comprises a channel along the first plate through which a fluid may be directed to flow to impart heat to the battery pack. In some embodiments, the system comprises a channel along the second plate through which a fluid may be directed to flow to impart heat to the battery pack. The interstitial member may comprise a thermally conductive material. The heat may be imparted to the battery pack from the first plate in a different direction than the heat is imparted to the battery pack from the second plate.

Provided herein is a method for thermal management of a battery pack comprising: providing the battery pack comprising a plurality of cells and an interstitial member between at least two cell of the plurality of cells; providing a plurality of plates coupled to the interstitial member; providing a control element capable of flowing a cooling fluid along the plurality of plates; wherein the control element is capable of drawing heat generated by the battery pack in a first direction from the interstitial member to a first plate of the plurality of plates; wherein the control element is capable of drawing heat generated by the battery pack in a second direction from the interstitial member to a second plate of the plurality of plates, wherein the interstitial member comprises a thermally conductive material, and wherein the first direction is a different direction than the second direction. Provided herein is a method for thermally managing a battery pack comprising: providing the battery pack comprising a plurality of cells and an interstitial member comprising a thermally conductive material between at least two cells of the plurality of cells; providing a first plate coupled to the interstitial member; imparting heat to the battery pack from the interstitial member and from the first plate wherein imparting the heat comprises flowing a warming fluid along the first plate in a first flow direction, and flowing the warming fluid along the first plate in a second flow direction.

In some embodiments, the thermal management cools the battery pack. In some embodiments, the thermal management heats the battery pack. In some embodiments, the thermal management cools at least one cell of the battery pack, and heats at least one cell of the battery pack.

The methods herein may be used in an electric vehicle, a hybrid electric vehicle, or in another application that requires a battery pack.

In some embodiments, the method comprises placing the first plate adjacent a first surface of the battery pack, and placing the second plate adjacent a second surface of the battery pack.

In some embodiments, the method comprises drawing heat generated by the battery pack in a third direction from the interstitial member to a third plate of the plurality of plates.

In some embodiments, flowing a cooling fluid along the first plate in a first flow direction, and flowing the warming fluid along the first plate in a second flow direction is done simultaneously.

FIG. 2 depicts a battery pack 102 having an interstitial member 108a, 108b between the cells (cells 104a, 104b, 104c, 104d for example) of the pack 102 that is coupled to a plurality of plates (a first plate 110a on the bottom of the pack, a second plate 110b along a first side of the pack, and a third plate 110c along a second side of the pack), and having cooling fluid 112 flowing along each of the plates (in the direction shown by the arrows next to the fluid call-outs 112, for example).

In some embodiments of the systems and methods provided herein, the first plate 110a is adjacent a first surface of the battery pack 102, and the second plate 110b is adjacent a second surface of the battery pack 102.

In some embodiments of the systems and methods provided herein, the first plate 110a, and the second plate 110b are coupled to the interstitial member 108a (and/or interstitial member 108b). The interstitial member may be located in the interstitial space 106 between adjacent cells of the battery pack 102.

In some embodiments of the systems and methods provided herein, at least one of the first plate 110a and the second plate 110b comprises the thermally conductive material. In some embodiments, at least one of the first plate 110a and the second plate 110b comprises a plurality of layers of the thermally conductive material.

In some embodiments of the systems and methods provided herein, the first plate 110a and the second plate 110b cool a plurality of surfaces of the battery pack 102.

In some embodiments of the systems and methods provided herein, the system comprises a third plate 110c coupled to the interstitial member 108b (and/or interstitial member 108a).

In some embodiments, the thermally conductive material comprises metal. In some embodiments, the thermally conductive material comprises a metal alloy. In some embodiments, the thermally conductive material comprises aluminum. In some embodiments, the thermally conductive material comprises aluminum alloy. In some embodiments, the thermally conductive material comprises aluminum foil. In some embodiments, the thermally conductive material comprises aluminum alloy foil. In some embodiments, the thermally conductive material comprises aluminum alloy sheet. In some embodiments, the thermally conductive material comprises another thermally conductive material between 0.05 mm and 4 mm thick.

In some embodiments of the systems and methods provided herein, the interstitial member and at least one of the first plate and the second plate are contiguous.

In some embodiments, at least one of the first plate and the second plate creates thermal homogeneity of the battery pack. In some embodiments, at least one of the first plate and the second plate uses regenerative heat exchange to create thermal homogeneity of the battery pack. In some embodiments, thermal homogeneity of the battery pack comprises a battery pack temperature gradient of at least one of at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least. As used herein, the term “degrees Celsius” is interchangeably and synonymous with “C”.

Provided herein is a method for cooling a cell of a battery pack comprising: providing the battery pack and an interstitial member between the cell and a structure adjacent the cell. In some embodiments, the structure comprises a second cell of the battery pack. In some embodiments, the structure is not a cell of the battery pack. In some embodiments, the method comprises providing a plurality of plates coupled to the interstitial member. In some embodiments the method comprises providing a control element capable of flowing a cooling fluid along the plurality of plates. In some embodiments, the control element is capable of drawing heat generated by the battery pack in a first direction from the interstitial member to a first plate of the plurality of plates. In some embodiments, the control element is capable of drawing heat generated by the battery pack in a second direction from the interstitial member to a second plate of the plurality of plates. In some embodiments, the interstitial member comprises a thermally conductive material. In some embodiments, the first direction is a different direction than the second direction. The method may be used in an electric vehicle, a hybrid electric vehicle, or in another application that requires a cell pack. In some embodiments, a cooling fluid is a fluid that is capable of cooling a cell of the battery pack.

Provided herein is a method comprising providing a system for thermal management of a battery pack. In some embodiments, a battery pack may comprise a single cell. In some embodiments, a battery pack may comprise a plurality of cells. The system may be used in an electric vehicle, a hybrid electric vehicle, or in another application that requires a battery pack. The system may comprise a battery pack comprising a plurality of cells; an interstitial member between at least two cell of the plurality of cells; a first plate coupled to the interstitial member; a second plate coupled to interstitial member; and a flowing fluid capable of drawing heat generated by the battery pack from the interstitial member to the first plate and for drawing the heat generated by the battery pack from the interstitial member to the second plate, wherein the interstitial member comprises a thermally conductive material, and wherein the heat is drawn to the first plate in a different direction than the heat is drawn to the second plate.

Provided herein is a method for thermal management of a battery pack comprising providing an interstitial member between cells of a battery pack, the interstitial member comprising a thermally conductive material and being coupled to at least one plate along which a fluid may flow to conductively cool the cells of the battery pack. In some embodiments, the fluid does not flow between the cells of the battery pack.

Provided herein is a method for thermal management of a battery pack comprising flowing a cooling fluid along a plate coupled to an interstitial member comprised of a thermally conductive material. The interstitial member is between at least one cell and a structure adjacent to the cell, said structure may or may not be a second battery. In some embodiments, the fluid does not flow between the cells of the battery pack. In some embodiments the method comprises flowing the fluid along a second plate coupled to the interstitial member or a second interstitial member comprised of a thermally conductive material. The second interstitial member is between at least one cell and a structure adjacent to the cell, said structure may or may not be a second cell. In some embodiments the method comprises controlling the direction of flow of the fluid to keep the cell below a target temperature.

In some embodiments, the thermal management cools the battery pack. In some embodiments, the thermal management heats the battery pack. In some embodiments, the thermal management cools at least one cell of the battery pack, and heats at least one cell of the battery pack.

In some embodiments, at least one of the first plate and the second plate creates thermal homogeneity of the battery pack. In some embodiments, at least one of the first plate and the second plate uses regenerative heat exchange to create thermal homogeneity of the battery pack. In some embodiments, thermal homogeneity of the battery pack comprises a battery pack temperature gradient of at least one of at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

### Fluid Reversal

The fluid flow, which is used to transfer heat to and from the cooled layer, may be in contact with the cooled layer (or plate) or it may be in a thermally conducting circuit next to the cooled surface. The flow of this fluid may be reversed in direction periodically in order to minimize the thermal gradient along the path. Additionally a control loop may be used to optimize the time spent flowing fluid in each direction. This concept may also be applied along multiple surfaces adjacent to the pack, as described herein.

Provided herein is a system for thermal management of a battery pack. In some embodiments, a battery pack may comprise a single cell. In some embodiments, a battery pack may comprise a plurality of cells. The system may be used in an electric vehicle, a hybrid electric vehicle, or in another application that requires a battery pack. The system comprises: a battery pack comprising a plurality of cells; an interstitial member between at least two cell of the plurality of cells; a first plate coupled to the interstitial member; and a fluid capable of drawing heat generated by the battery pack from the interstitial member to the first plate, wherein the interstitial member comprises a thermally conductive material, and wherein the fluid changes from a first flow direction to a second flow direction.

Provided herein is a system for thermal management of a battery pack comprising: the battery pack comprising a plurality of cells; an interstitial member between at least two cell of the plurality of cells; a first plate coupled to the interstitial member; and a fluid capable of imparting heat to the first plate to the interstitial member and to the battery pack, wherein the interstitial member comprises a thermally conductive material, and wherein the fluid changes from a first flow direction to a second flow direction.

Provided herein is a system for cooling a cell of a battery pack. In some embodiments, a battery pack may comprise a single cell. In some embodiments, a battery pack may comprise a plurality of cells. The system may be used in an electric vehicle, a hybrid electric vehicle, or in another application that requires a battery pack. The system comprises a battery pack comprising an interstitial member between at least a cell of the battery pack and a structure adjacent the cell that may or may not be a second cell, depending on the embodiment. The system comprises a first plate coupled to the interstitial member. In some embodiments, the system comprises a control element capable of flowing a fluid to draw heat generated by the battery pack from the interstitial member to the first plate. In some embodiments, the interstitial member comprises a thermally conductive material. In some embodiments the control element of the system is capable of changing the flow of the fluid from a first flow direction to a second flow direction. In some embodiments, the system comprises a channel along the first plate through which a fluid may be directed to flow to draw heat generated by the battery pack from the interstitial member to the first plate. In some embodiments, a flowing fluid is a fluid that is capable of flowing.

In some embodiments, the plate acts as a direct contact heat exchanger between the flowing fluid and the interstitial member. In some embodiments the plate is a multi-pass heat exchanger.

Provided herein is a method for thermal management of a battery pack comprising: providing the battery pack comprising a plurality of cells and an interstitial member comprising a thermally conductive material between at least two cell of the plurality of cells; providing a first plate coupled to the interstitial member; drawing heat generated by the battery pack from the interstitial member to the first plate wherein drawing the heat comprises flowing a fluid along the first plate in a first flow direction, and flowing the fluid along the first plate in a second flow direction. The method may be used in an electric vehicle, a hybrid electric vehicle, or in another application that requires a battery pack.

In some embodiments, the thermal management cools the battery pack. In some embodiments, the thermal management heats the battery pack. In some embodiments, the thermal management cools at least one cell of the battery pack, and heats at least one cell of the battery pack.

In some embodiments, the method comprises (and/or the system is capable of) flowing a fluid along the first plate in a first flow direction, and flowing the fluid along the first plate in a second flow direction is done simultaneously.

In some embodiments of the methods and systems provided herein, the first flow direction is a different direction than the second flow direction.

In some embodiments of the methods and systems provided herein, the first flow direction is 90 degrees rotated from the second flow direction.

In some embodiments, the method comprises (and/or the system is capable of) changing the second flow direction to the first flow direction. In some embodiments, the method comprises (and/or the system is capable of) changing between the first flow direction and the second flow direction in response to at least one of: a predetermined time interval, the fluid (whether cooling fluid, warming fluid, and/or flowing fluid) reaching a predetermined temperature, the fluid (whether cooling fluid, warming fluid, and/or flowing fluid) reaching a predetermined temperature at a predetermined location, the fluid (whether cooling fluid, warming fluid, and/or flowing fluid) reaching a predetermined temperature at one of a plurality of predetermined locations, a temperature of at least one cell in the battery pack, a cold spot location in the battery pack, a hot spot location in the battery pack, and the battery pack temperature gradient.

In some embodiments of the methods and systems provided herein, the interval is periodic.

In some embodiments, the method comprises (and/or the system is capable of) changing at least one of the first flow direction and the second flow direction to a third flow direction. In some embodiments, the method comprises (and/or the system is capable of) changing among the first flow direction, the second flow direction, and a third flow direction in response to at least one of: a predetermined time interval, the fluid (whether cooling fluid, warming fluid, and/or flowing fluid) reaching a predetermined temperature, the fluid (whether cooling fluid, warming fluid, and/or flowing fluid) reaching a predetermined temperature at a predetermined location, the fluid (whether cooling fluid, warming fluid, and/or flowing fluid) reaching a predetermined temperature at one of a plurality of predetermined locations, a temperature of at least one cell in the battery pack, a cold spot location in the battery pack, a hot spot location in the battery pack, and the battery pack temperature gradient.

In some embodiments, the method comprises (and/or the system is capable of) changing among the first flow direction, the second flow direction, a third flow direction, and a fourth flow direction in response to at least one of a predetermined time interval, the fluid (whether cooling fluid, warming fluid, and/or flowing fluid) reaching a predetermined temperature, the fluid (whether cooling fluid, warming fluid, and/or flowing fluid) reaching a predetermined temperature at a predetermined location, the fluid (whether cooling fluid, warming fluid, and/or flowing fluid) reaching a predetermined temperature at one of a plurality of predetermined locations, a temperature of at least one cell in the battery pack, a cold spot location in the battery pack, a hot spot location in the battery pack, and the battery pack temperature gradient.

In some embodiments, the method comprises (and/or the system is capable of) providing a second plate coupled to the interstitial member.

In some embodiments, the method comprises (and/or the system is capable of) flowing the fluid in the first flow direction flows the fluid along the second plate in the first flow direction. In some embodiments, the method comprises (and/or the system is capable of) flowing the fluid in the second flow direction which flows the fluid along the second plate in the second flow direction. In some embodiments, the method comprises (and/or the system is capable of) flowing the fluid in the first flow direction which flows the fluid along the first plate and the second plate in the first flow direction. In some embodiments, the method comprises (and/or the system is capable of) flowing the fluid in the second flow direction which flows the fluid along the first plate and the second plate in the second flow direction. In some embodiments, the method comprises (and/or the system is capable of) flowing the fluid in the first flow direction which flows the fluid along the first plate in the second flow direction, and the method comprises (and/or the system is capable of) flowing the fluid in the second flow direction which flows the fluid along the second plate in the second flow direction.

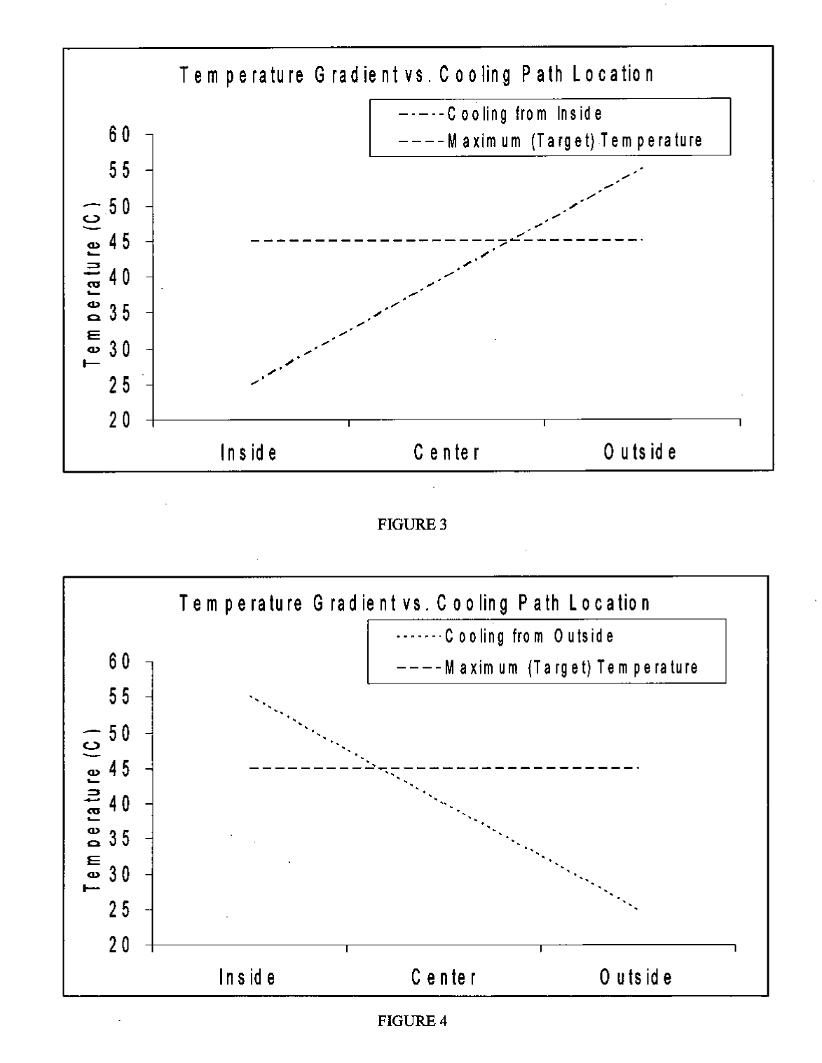

FIG. 3 depicts a chart showing the temperature gradient of a battery pack in which fluid flows in a single direction along a path from the inside 122, through the center 124, to the outside 126 of the battery pack, such as is depicted in FIG. 2, and which may exhibit a higher temperature than a target temperature at the end of the fluid path (the outside 126 of the battery pack). In such an embodiment, the fluid is at a lower temperature than the pack when it first touches the plate (at the inside location), and as it heats up by drawing heat from the pack, the fluid temperature rises and becomes less efficient at lowering the plate temperature as the fluid moves across the plate from the inside to the center to the outside location. Thus the resultant plate temperature is such that the inside is the coolest, the center is higher than the inside, and the outside is the warmest location. The chart depicts the Maximum (Target) Temperature as the line that level with the x axis (at 45 C in FIG. 3, but which may be another target, as noted herein depending on various system attributes and configurations). The chart depicts in the line that starts closest to the x-y intercept (and is a dash-dot-dash-dot) the temperature gradient when flow is directed from the inside to the center to the outside (as is shown in FIG. 2, for example). In an embodiment wherein the fluid were warmer than the plate, the slope of the temperature of the plate would be the opposite (or negative) of the slope shown in FIG. 3, and the temperature at the inside would be the warmest (where the fluid heated the cells more efficiently), and the temperature would decrease across the plate from the inside to the center to the outside, as the fluid cooled moving across the plate.

For naming purposes only, the battery pack of FIG. 2, for example, is labeled as having an inside, a center, an outside, a front, and a back. These names for locations within the battery pack are chosen for clarity only in order to provide reference points to aid in describing the fluid flow path and temperature gradients depending on the direction of flow at a particular time (or over time)—and not because the battery pack locations are inside, center to, or outside relative to any particular other element of the system, or in front of or in back of a particular element of the system, although they may be. The names provide reference points for ease of description.

In some embodiments of the methods and systems provided herein, as is shown in FIG. 3, the target maximum temperature is 45 degrees Celsius. The target maximum temperature, in some embodiments, is the temperature that the system is programmed to keep the cells at or below. The target maximum temperature, in some embodiments, is the temperature that the system can control the battery pack to be below by altering the flow of the fluid along the plate (or plates) of the system. The target maximum temperature, in some embodiments, is the minimum temperature at which a cell of the battery pack begins to degrade. In some embodiments, the target maximum temperature is at least one of about 1 C (degrees Celsius), about 5 C, about 10 C, about 20 C, about 25 C, about 30 C, about 35 C, about 40 C, about 45 C, about 50 C, about 55 C, about 60 C, about 65 C, about 70 C, about 75 C, about 80 C, about 85 C, about 90 C, about 95 C, and about 100 C. In some embodiments, the target temperature range (or temperature range) is at least one of: about 1 C to about 5 C, about 1 C to about 10 C, about 1 C to about 30 C, about 10 C to about 20 C, about 10 C to about 30 C, about 25 C to about 50 C, about 20 C to about 30 C, about 30 C to about 40 C, about 40 C to about 50 C, about 50 C to about 60 C, about 60 C to about 70 C, about 70 C to about 80 C, about 80 C to about 90 C, about 100 C, about 90 C to about 100 C, about 25 C to about 75 C, about 30 C to about 60 C, about 40 C to about 60 C, about 50 C to about 100 C, about 50 C to about 75 C, about 60 C to about 80 C, about 75 C to about 100 C, about 75 C to about 90 C, about 80 C to about 100 C, about 75 C to about 80 C, about 20 to about 25 C, about 25 C to about 30 C, about 30 C to about 35 C, about 35 C to about 40 C, about 40 C to about 45 C, about 45 C to about 50 C, about 50 C to about 55 C, about 55 C to about 60 C, about 60 C to about 65 C, about 65 C to about 70 C, about 70 C to about 75 C, about 75 C to about 80 C, about 80 C to about 85 C, about 85 C to about 90 C, about 90 C to about 95 C, and about 95 C to about 100 C. As used herein, the term “about” is meant as a range of at least one of: 1 C, 2 C, 5 C, 10%, 15%, and 25%. In some embodiments, the target maximum temperature is chosen based upon the cell type (materials, composition, size, shape), pack design (i.e. number of cells, locations and arrangements of cells, locations, materials, and/or configurations of the interstitial members and/or plates), fluid flow capabilities (e.g. multiple flow directions possible, flow along multiple plates, simultaneous multi-directional flow), and/or temperature and/or composition of the fluid, for non-limiting example.

In some embodiments, at least one of the first plate and the second plate creates thermal homogeneity of the battery pack. In some embodiments, at least one of the first plate and the second plate uses regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

FIG. 4 depicts a chart showing the temperature gradient of a battery pack in which cooling fluid flows in a single direction which is opposite (or reversed) as compared to that depicted in FIG. 3, which may be exhibit a higher temperature than a target temperature at the end of the fluid path (the inside 122). The chart depicts the Maximum (Target) temperature as the line that level with the x axis (at 45 C in FIG. 4, but which may be another target, as noted herein depending on various system attributes and configurations). The chart further depicts in the line that starts at the highest temperature on the inside (and is a dotted line) the temperature gradient when flow is directed only from the outside to the center to the inside (the reverse direction as that shown in FIG. 2). In such an embodiment, the fluid is at a lower temperature than the pack when it first touches the plate (at the outside location), and as it heats up by drawing heat from the pack, the fluid temperature rises and becomes less efficient at lowering the plate temperature as the fluid moves across the plate from the outside to the center to the inside location. Thus the resultant plate temperature is such that the outside is the coolest, the center is higher than the outside, and the inside is the warmest location. In an embodiment wherein the fluid were warmer than the plate (not depicted), the slope of the temperature of the plate would be the opposite (or negative) of the slope shown in FIG. 4, and the temperature at the outside would be the warmest (where the fluid heated the cells more efficiently), and the temperature would decrease across the plate from the outside to the center to the inside, as the fluid cooled moving across the plate.

FIG. 5 depicts a chart showing the temperature gradient of a battery pack in which cooling fluid alternates flow between a first direction and a second direction which is the reverse direction of the first direction. which may result in a peak temperature in about the center of the flow path, but which can maintain the entire pack temperature below a target temperature. By alternating the fluid flow direction between two flow directions (e.g. a first flow direction and a second flow direction that is opposite or reverse of the first flow direction), a steady state temperature gradient of either flow direction is not reached. The period (or interval) of alternation may be maximized to the maximum interval (time elapse) which allows the system to remain within the specification temperature (i.e. below or at a target temperature, or within a battery pack temperature gradient). The chart depicts the Maximum (Target) temperature as the line that level with the x axis (at 45 C in FIG. 5, but which may be another target (or target temperature range), as noted herein depending on various system attributes and configurations). The chart depicts in the line that starts closest to the x-y intercept (and is a dash-dot-dash-dot) the temperature gradient when flow is directed from the inside to the center to the outside (as is shown in FIG. 2, for example). The chart further depicts in the line that starts at the highest temperature on the inside (and is a dotted line) the temperature gradient when flow is directed only from the outside to the center to the inside (the reverse direction to that depicted in FIG. 2). The average result of alternating the flow direction is shown in the curved solid line, labeled “Alternating (Inside<—>Outside).” When alternating the direction of fluid flow, as shown in FIG. 5, the maximum temperature that the battery pack reaches can be reduced as compared to temperatures reached in single-direction flow embodiments. When alternating the direction of fluid flow, as shown in FIG. 5, the average peak temperature that the battery pack reaches also can be reduced as compared to temperatures reached in single-direction flow embodiments. Alternatively, where the system is used to warm the cells using a fluid that is warmer than the cells, the solid line of FIG. 5 would be the opposite as is shown (the negative of the line shown—higher at the inside than at the center and higher at the outside than at the center).

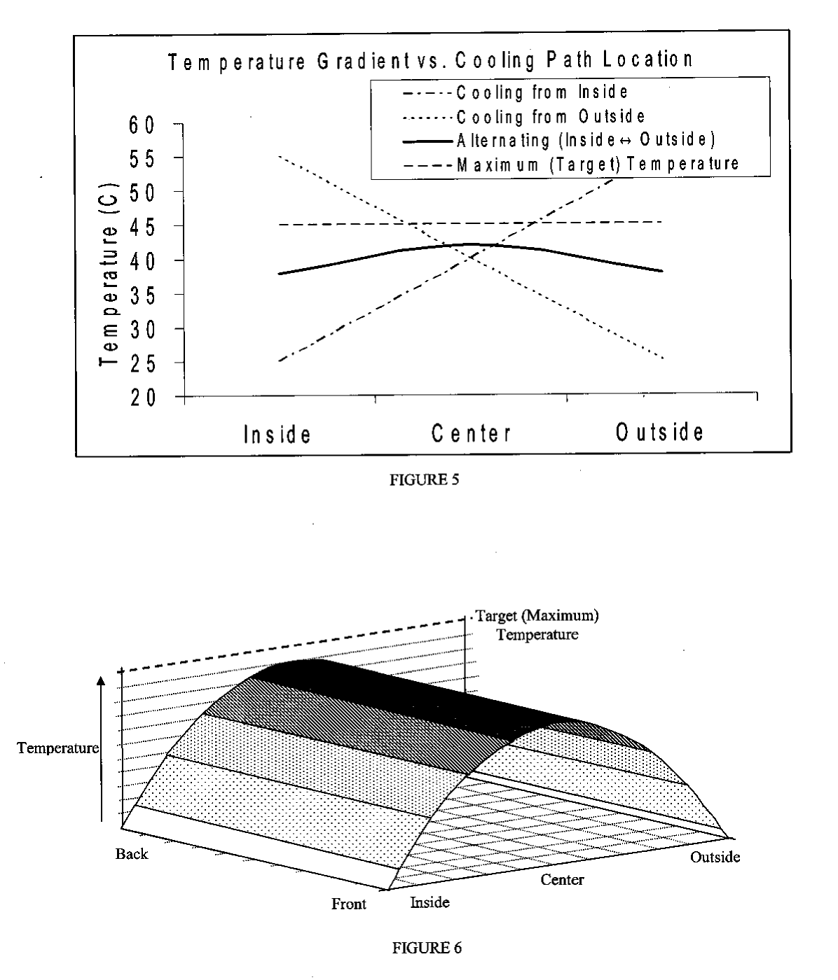

FIG. 6 is a chart showing the temperature gradient of a battery pack in which cooling fluid flows (either simultaneously, in part simultaneously, or alternating depending on the embodiment) along the pack in a plurality of directions, including a first flow direction and a second flow direction which is the reverse of the first flow direction. FIG. 6 is a 3-dimensional depiction of the temperature of the battery pack having rows and columns of cells and having fluid flowing from the inside to the center to the outside (a first flow direction), and reversing such flow such that the fluid flows from the outside to the center to the inside (a second flow direction). FIG. 6 also depicts that with such flow, the maximum temperature of the battery pack can be maintained below a target maximum temperature. The shading in FIG. 6 is provided to show temperature differences (darker shading is hotter than lighter shading) at the different locations of the cell noted (e.g. inside, center, outside, back, front), which is also shown by the height of the 3-d surface in the y-direction (the higher the surface along the y-axis, the hotter are the cells in the shown location in the battery pack). In this embodiment depicted in FIG. 6, the fluid is a cooling fluid that reverses direction, as is also shown in FIG. 5, however FIG. 6 shows the 3-dimensional effect over a battery pack having more than a single row of cells inside to outside. As noted in reference to FIG. 5, the surface curve would be flipped such that the inside would have a higher temperature than the center, and the outside would have a higher temperature than the center, in the embodiments wherein the fluid is a higher temperature than the cells (a battery pack warming system or method).

In some embodiments of the methods and systems provided herein, the first plate is on multiple surfaces of the battery pack.

In some embodiments of the methods and systems provided herein, the first flow direction is the reverse direction of the second flow direction.

In some embodiments of the methods and systems provided herein, the first flow direction is the reverse direction of the second flow direction. In some embodiments, the first flow direction is a different direction than the second flow direction. In some embodiments, the first flow direction is 90 degrees rotated from the second flow direction.

In some embodiments of the methods and systems provided herein, the system comprises a control element capable of changing the first flow direction to the second flow direction in response to the flowing fluid reaching a predetermined temperature. In some embodiments, the predetermined temperature is at least one of about 1 C (degrees Celsius), about 5 C, about 10 C, about 20 C, about 25 C, about 30 C, about 35 C, about 40 C, about 45 C, about 50 C, about 55 C, about 60 C, about 65 C, about 70 C, about 75 C, about 80 C, about 85 C, about 90 C, about 95 C, and about 100 C. In some embodiments, the target temperature range (or temperature range) is at least one of: about 1 C to about 5 C, about 1 C to about IOC, about 1 C to about 30 C, about 10 C to about 20 C, about 10 C to about 30 C, about 25 C to about 50 C, about 20 C to about 30 C, about 30 C to about 40 C, about 40 C to about 50 C, about 50 C to about 60 C, about 60 C to about 70 C, about 70 C to about 80 C, about 80 C to about 90 C, about 90 C to about 100 C, about 25 C to about 75 C, about 30 C to about 60 C, about 40 C to about 60 C, about 50 C to about 100 C, about 50 C to about 75 C, about 60 C to about 80 C, about 75 C to about 100 C, about 75 C to about 90 C, about 80 C to about 100 C, about 75 C to about 80 C, about 20 to about 25 C, about 25 C to about 30 C, about 30 C to about 35 C, about 35 C to about 40 C, about 40 C to about 45 C, about 45 C to about 50 C, about 50 C to about 55 C, about 55 C to about 60 C, about 60 C to about 65 C, about 65 C to about 70 C, about 70 C to about 75 C, about 75 C to about 80 C, about 80 C to about 85 C, about 85 C to about 90 C, about 90 C to about 95 C, and about 95 C to about 100 C. As used herein, the term “about” is meant as a range of at least one of: 1 C, 2 C, 5 C, 10%, 15%, and 25%. In some embodiments, the predetermined temperature is chosen based upon the cell type (materials, composition, size, shape), pack design (i.e. number of cells, locations and arrangements of cells, locations, materials, and/or configurations of the interstitial members and/or plates), fluid flow capabilities (e.g. multiple flow directions possible, flow along multiple plates, simultaneous multi-directional flow), and/or temperature and/or composition of the fluid, for non-limiting example.

In some embodiments, the plate (or plates) create thermal homogeneity of the battery pack. In some embodiments, the plate (or plates) use regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments of the methods and systems provided herein, the system comprises a control element capable of changing the first flow direction to the second flow direction at a predetermined interval.

In some embodiments of the methods and systems provided herein, the interval is periodic. In some embodiments of the methods and systems provided herein, the flowing fluid changes from the second flow direction to the first flow direction.

In some embodiments of the methods and systems provided herein, the system comprises a control element capable of changing the second flow direction to the first flow direction in response to the flowing fluid reaching a predetermined temperature. In some embodiments, the predetermined temperature is at least one of about 1 C (degrees Celsius), about 5 C, about 10 C, about 20 C, about 25 C, about 30 C, about 35 C, about 40 C, about 45 C, about 50 C, about 55 C, about 60 C, about 65 C, about 70 C, about 75 C, about 80 C, about 85 C, about 90 C, about 95 C, and about 100 C. In some embodiments, the target temperature range (or temperature range) is at least one of: about 1 C to about 5 C, about 1 C to about 10 C, about 1 C to about 30 C, about 10 C to about 20 C, about 10 C to about 30 C, about 25 C to about 50 C, about 20 C to about 30 C, about 30 C to about 40 C, about 40 C to about 50 C, about 50 C to about 60 C, about 60 C to about 70 C, about 70 C to about 80 C, about 80 C to about 90 C, about 90 C to about 100 C, about 25 C to about 75 C, about 30 C to about 60 C, about 40 C to about 60 C, about 50 C to about 100 C, about 50 C to about 75 C, about 60 C to about 80 C, about 75 C to about 100 C, about 75 C to about 90 C, about 80 C to about 100 C, about 75 C to about 80 C, about 20 to about 25 C, about 25 C to about 30 C, about 30 C to about 35 C, about 35 C to about 40 C, about 40 C to about 45 C, about 45 C to about 50 C, about 50 C to about 55 C, about 55 C to about 60 C, about 60 C to about 65 C, about 65 C to about 70 C, about 70 C to about 75 C, about 75 C to about SOC, about 80 C to about 85 C, about 85 C to about 90 C, about 90 C to about 95 C, and about 95 C to about 100 C. As used herein, the term “about” is meant as a range of at least one of: 1 C, 2 C, 5 C, 10%, 15%, and 25%. In some embodiments, the predetermined temperature is chosen based upon the cell type (materials, composition, size, shape), pack design (i.e. number of cells, locations and arrangements of cells, locations, materials, and/or configurations of the interstitial members and/or plates), fluid flow capabilities (e.g. multiple flow directions possible, flow along multiple plates, simultaneous multi-directional flow), and/or temperature and/or composition of the fluid, for non-limiting example.

In some embodiments, the plate (or plates) create thermal homogeneity of the battery pack. In some embodiments, the plate (or plates) use regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the system comprises a control element capable of changing the second flow direction to the first flow direction at a predetermined interval.

In some embodiments of the methods and systems provided herein, the cooling flowing fluid periodically changes from the second flow direction to a third flow direction.

Provided herein is a method for cooling a cell of a battery pack comprising: providing the battery pack and an interstitial member between the cell and a structure adjacent the cell. In some embodiments, the structure comprises a second cell of the battery pack. In some embodiments, the structure is not a cell of the battery pack. In some embodiments, the method comprises providing a plate coupled to the interstitial member. In some embodiments the method comprises providing a control element capable of flowing a fluid along the plate. In some embodiments, the control element is capable of drawing heat generated by the battery pack in a first direction from the interstitial member to the plate. In some embodiments, the control element is capable of changing the direction of the fluid from a first flow direction to a second flow direction. In some embodiments, the interstitial member comprises a thermally conductive material. In some embodiments, the first flow direction is a different direction than the second flow direction. The method may be used in an electric vehicle, a hybrid electric vehicle, or in another application that requires a battery pack. In some embodiments, a fluid is a fluid that is capable of cooling a cell of the battery pack. In some embodiments, a fluid is a cooling fluid. In some embodiments, a fluid is a fluid that is capable of warming a cell of the battery pack. In some embodiments, a fluid is a warming fluid.

Provided herein is a method comprising providing a system for thermal management of a battery pack. In some embodiments, a battery pack may comprise a single cell. In some embodiments, a battery pack may comprise a plurality of cells. The system may be used in an electric vehicle, a hybrid electric vehicle, or in another application that requires a battery pack. The system may comprise a battery pack comprising a plurality of cells; an interstitial member between at least two cell of the plurality of cells; a first plate coupled to the interstitial member; and a control element capable of flowing a fluid to draw heat generated by the battery pack from the interstitial member to the first plate, wherein the interstitial member comprises a thermally conductive material, and wherein the control element is capable of changing the direction of the fluid from a first flow direction to a second flow direction along the first plate.

Provided herein is a method for thermal management of a battery pack comprising providing an interstitial member between cells of a battery pack, the interstitial member comprising a thermally conductive material and being coupled to at least one plate along which a fluid may flow in multiple directions sequentially to conductively cool (and/or heat, in some embodiment)s the cells of the battery pack. In some embodiments, the fluid does not flow between the cells of the battery pack. Provided herein is a method for thermal management of a battery pack comprising providing an interstitial member between cells of a battery pack, the interstitial member comprising a thermally conductive material and being coupled to at least one plate along which a fluid may flow in multiple directions concurrently to conductively cool (and/or heat, in some embodiment)s the cells of the battery pack. In some embodiments, the fluid does not flow between the cells of the battery pack.

Provided herein is a method for thermal management of a battery pack comprising flowing a cooling fluid along a plate coupled to an interstitial member comprised of a thermally conductive material. The interstitial member is between at least a first cell and a structure adjacent to the first cell, said structure may or may not be a second cell. In some embodiments, the fluid does not flow between cells of a battery pack wherein the battery pack comprises a plurality of cells. In some embodiments, the method comprises changing the direction of flow of fluid from a first direction to a second direction. In some embodiments, the first direction is the reverse of the second direction. In some embodiments the first direction is different from the second direction. In some embodiments the method comprises controlling the direction of flow of the fluid to keep the cell below a target temperature. In some embodiments the first direction is different from the second direction. In some embodiments the method comprises controlling the direction of flow of the fluid to keep the cell above a target temperature. In some embodiments the method comprises controlling the direction of flow of the fluid to keep the battery pack within a battery pack temperature gradient, as described herein.

In some embodiments, the thermal management cools the battery pack. In some embodiments, the thermal management heats the battery pack. In some embodiments, the thermal management cools at least one cell of the battery pack, and heats at least one cell of the battery pack.

### Multi-Directional Fluid Flow

The fluid of some embodiments may be channeled to flow in multiple directions across the cooled surface. In some embodiments, the system comprises a control element capable of changing at least one of the first flow direction and the second flow direction to a third flow direction. In some embodiments, the system comprises a control element capable of changing at least one of the first flow direction and the second flow direction to a third flow direction or a fourth flow direction. The fluid of some embodiments may be channeled to flow in multiple directions across the cooled surface. The fluid of some embodiments may be channeled to flow in multiple directions across the cooled surface concurrently (at the same time), and/or sequentially.

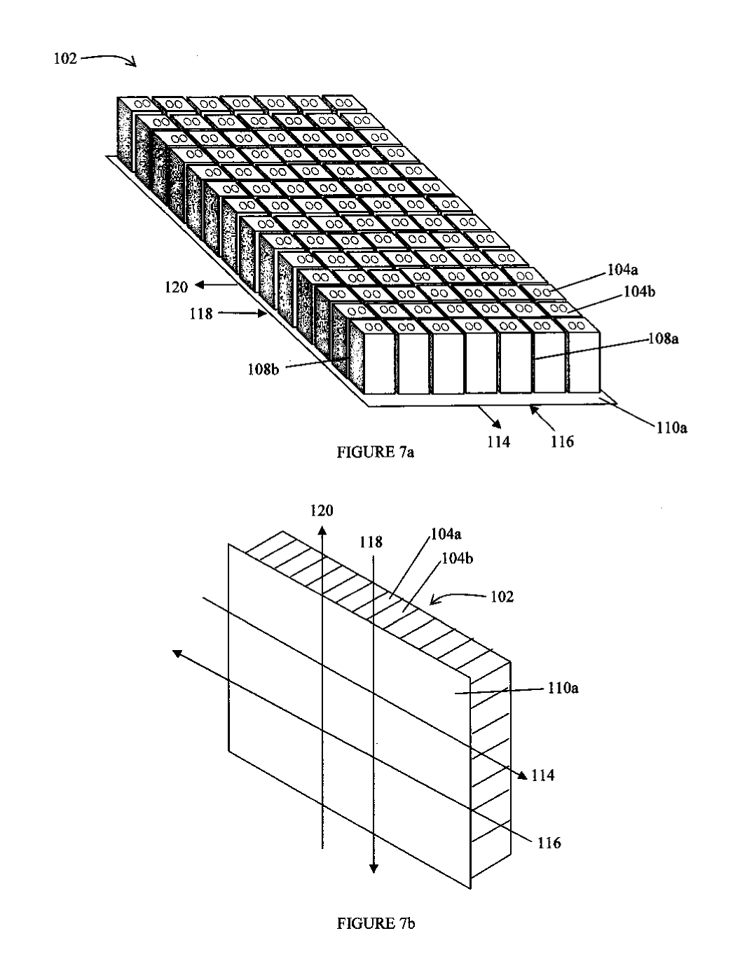

FIGS. 7a and 7b depict a battery pack 102 comprising a plurality of cells (e.g. cell 104a, 104h) in which cooling fluid flows along the plate 110a in a plurality of directions, including a first flow direction 114, a second flow direction 116 which is the reverse of the first flow direction 114, a third flow direction 118 which is generally orthogonal to at least one of the first flow direction 114 and the second flow direction 116, and a fourth flow direction 120 which is the reverse of the third flow direction 118. In some embodiments, a battery pack may comprise a single cell. In some embodiments, a battery pack may comprise a plurality of cells. It is contemplated that fluid flow can be in a multitude of directions (not necessarily only in orthogonal directions), depending on the configuration of the cells of the battery pack, the number and locations of plate(s), and the target maximum temperatures desired (based on the cell materials, interstitial member 108a, 108b materials, fluid composition, plate 110a materials and composition) among other factors. Likewise, it is contemplated that fluid flow in multiple directions can be simultaneous or at different times.

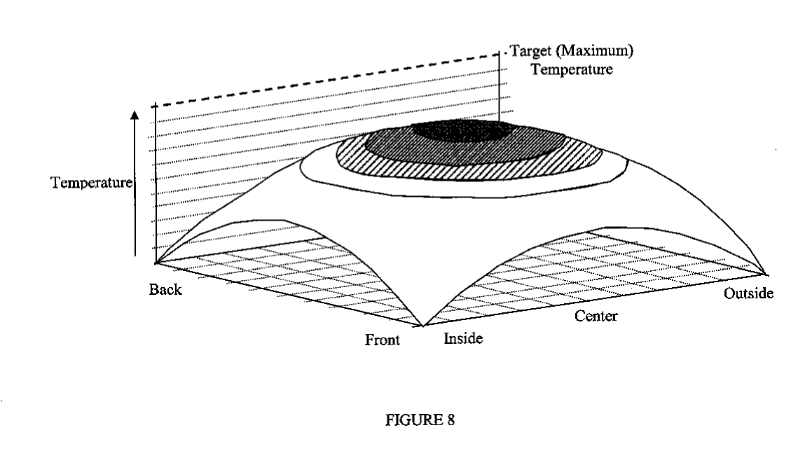

FIG. 8 chart showing the temperature gradient of a battery pack in which cooling fluid flows (either simultaneously, in part simultaneously, or alternating depending on the embodiment) along the pack in a plurality of directions, including a first flow direction (inside to outside), a second flow direction (outside to inside) which is the reverse of the first flow direction, a third flow direction (front to hack) which is generally orthogonal to at least one of the first flow direction and the second flow direction, and a fourth flow direction (hack to front) which is the reverse of the third flow direction. The shading in FIG. 8 is provided to show temperature differences (darker shading is hotter than lighter shading) at the different locations of the cell noted, which is also shown by the height of the 3-d surface in the y-direction (the higher the surface, the hotter are the cells in the shown location in the battery pack). FIG. 8 also depicts that with such flow characteristics of the system, the maximum temperature of the battery pack can be maintained below a target maximum temperature. Additionally, assuming that all system configurations are generally the same between the systems of FIG. 6 and FIG. 8, the maximum temperature of FIG. 8 which employs a third and fourth flow direction in addition to the first and second flow direction can result in a lower maximum temperature of the battery pack (as compared to the maximum measured temperature of the battery pack of FIG. 6). In an embodiment wherein a fluid temperature is above that of the cells, the surface shown in FIG. 8 exhibits peak temperatures at the corners and a minimum temperature in the center of the surface (i.e. the center of the battery pack).

The temperature gradient of the 2-axis reversible flow also allows for an improvement over single axis reversible flow. The two axis flow will localize the pack of the gradient to a point in the center of the pack rather than a bisecting line as in the single axis reverse flow example. Further reduction in gradient may be realized by omitting cells (battery cells) at the center point of the pack, which is the most extreme point.

This type of multi-directional flow may also be applied to more than one plane adjacent to the battery pack, as was described previously.

As is explained in the single flow axis embodiment described herein, the flow may be controlled with a closed or open loop controller in order to optimize the duration of flow in each direction. In some embodiments, the change in flow direction is in response to the flowing fluid reaching a predetermined temperature. In some embodiments, the predetermined temperature is at least one of about 1 C (degrees Celsius), about 5 C, about 10 C, about 20 C, about 25 C, about 30 C, about 35 C, about 40 C, about 45 C, about 50 C, about 55 C, about 60 C, about 65 C, about 70 C, about 75 C, about 80 C, about 85 C, about 90 C, about 95 C, and about 100 C. In some embodiments, the target temperature range (or temperature range) is at least one of: about 1 C to about 5 C, about 1 C to about 10 C, about 1 C to about 30 C, about 10 C to about 20 C, about 10 C to about 30 C, about 25 C to about 50 C, about 20 C to about 30 C, about 30 C to about 40 C, about 40 C to about 50 C, about 50 C to about 60 C, about 60 C to about 70 C, about 70 C to about 80 C, about 80 C to about 90 C, about 90 C to about 100 C, about 25 C to about 75 C, about 30 C to about 60 C, about 40 C to about 60 C, about 50 C to about 100 C, about 50 C to about 75 C, about 60 C to about 80 C, about 75 C to about 100 C, about 75 C to about 90 C, about 80 C to about 100 C, about 75 C to about 80 C, about 20 to about 25 C, about 25 C to about 30 C, about 30 C to about 35 C, about 35 C to about 40 C, about 40 C to about 45 C, about 45 C to about 50 C, about 50 C to about 55 C, about 55 C to about 60 C, about 60 C to about 65 C, about 65 C to about 70 C, about 70 C to about 75 C, about 75 C to about 80 C, about 80 C to about 85 C, about 85 C to about 90 C, about 90 C to about 95 C, and about 95 C to about 100 C. As used herein, the term “about” is meant as a range of at least one of: 1 C, 2 C, 5 C, 10%, 15%, and 25%. In some embodiments, the predetermined temperature is chosen based upon the cell type (materials, composition, size, shape), pack design (i.e. number of cells, locations and arrangements of cells, locations, materials, and/or configurations of the interstitial members and/or plates), fluid flow capabilities (e.g. multiple flow directions possible, flow along multiple plates, simultaneous multi-directional flow), and/or temperature and/or composition of the fluid, for non-limiting example.

In some embodiments, the plate (or plates) create thermal homogeneity of the battery pack. In some embodiments, the plate (or plates) use regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the control element is capable of changing among the first flow direction, the second flow direction and the third flow direction in response to a temperature of at least one cell in the battery pack.

In some embodiments, the system comprises a control element capable of changing among the first flow direction, the second flow direction, a third flow direction, and a fourth flow direction in response to the flowing fluid reaching a predetermined temperature in one of a plurality of predetermined locations.

In some embodiments, the system comprises a control element capable of changing among the first flow direction, the second flow direction, a third flow direction, and a fourth flow direction in response to a temperature of at least one cell in the battery pack.

In some embodiments, the system comprises a control element capable of changing among the first flow direction, the second flow direction, and a third flow direction in response to a hot spot location in the battery pack. In some embodiments, the system comprises a control element capable of changing among the first flow direction, the second flow direction, and a third flow direction in response to a cold spot location in the battery pack.

In some embodiments, the system comprises a control element capable of applying the flowing fluid to the battery pack in an optimal flow direction.

Provided herein is a method for thermal management of a battery pack comprising: providing the battery pack comprising a plurality of cells and an interstitial member comprising a thermally conductive material between at least two cell of the plurality of cells; providing a first plate coupled to the interstitial member; drawing heat generated by the battery pack from the interstitial member to the first plate wherein drawing the heat comprises determining an optimal cooling fluid flow direction, and flowing the cooling fluid along the first plate in the optimal flow direction. The method may be used in an electric vehicle, a hybrid electric vehicle, or in another application that requires a battery pack.

In some embodiments, the thermal management cools the battery pack. In some embodiments, the thermal management heats the battery pack. In some embodiments, the thermal management cools at least one cell of the battery pack, and heats at least one cell of the battery pack.

In some embodiments, drawing heat comprises determining which of a first flow direction and a second flow direction is the optimal flow direction. In some embodiments, the optimal flow direction is chosen from a first flow direction and a second flow direction. In some embodiments, the optimal flow direction is chosen from a first flow direction, a second flow direction, and a third flow direction. In some embodiments, the optimal flow direction is chosen from a first flow direction, a second flow direction, a third flow direction, and a fourth flow direction.

In some embodiments, the optimal flow direction is the flow direction that will at least one of: lower the temperature of a hot spot location in the battery pack, lower the temperature of a cell of battery pack, lower a temperature of the flowing fluid, maintain the entire battery pack below a target temperature, raise the temperature of a cold spot location in the battery pack, raise the temperature of a cell of battery pack, raise a temperature of the fluid, maintain the entire battery pack above a target temperature, and maintain the battery pack within a battery pack temperature gradient.

In some embodiments, the optimal flow direction can change between a first flow direction and a second flow direction in order to at least one of: lower the temperature of a hot spot location in the battery pack, lower the temperature of a cell of battery pack, lower a temperature of the flowing fluid, maintain the entire battery pack below a target temperature, raise the temperature of a cold spot location in the battery pack, raise the temperature of a cell of battery pack, raise a temperature of the fluid, maintain the entire battery pack above a target temperature, and maintain the battery pack within a battery pack temperature gradient.

In some embodiments, the optimal flow direction can change among a first flow direction, a second flow direction, and a third flow direction in order to at least one of: lower the temperature of a hot spot location in the battery pack, lower the temperature of a cell of battery pack, lower a temperature of the flowing fluid, maintain the entire battery pack below a target temperature, raise the temperature of a cold spot location in the battery pack, raise the temperature of a cell of battery pack, raise a temperature of the fluid, maintain the entire battery pack above a target temperature, and maintain the battery pack within a battery pack temperature gradient.

In some embodiments, the optimal flow direction can change among a first flow direction, a second flow direction, a third flow direction, and a fourth flow direction in order to at least one of lower the temperature of a hot spot location in the battery pack, lower the temperature of a cell of battery pack, lower a temperature of the flowing fluid, and maintain the entire battery pack below a target temperature.

In some embodiments, the optimal flow direction can be a first flow direction along a first side of the battery pack, and at the same time be a second flow direction along a second side of the battery pack, and said optimal flow direction can be chosen in order to at least one of: lower the temperature of a hot spot location in the battery pack, lower the temperature of a cell of battery pack, lower a temperature of the flowing fluid, maintain the entire battery pack below a target temperature, raise the temperature of a cold spot location in the battery pack, raise the temperature of a cell of battery pack, raise a temperature of the fluid, maintain the entire battery pack above a target temperature, and maintain the battery pack within a battery pack temperature gradient.

In some embodiments, the optimal flow direction can be a first flow direction along the first plate, and at the same time be a second flow direction along a second plate coupled to the interstitial member, and said optimal flow direction can be chosen in order to at least one of lower the temperature of a hot spot location in the battery pack, lower the temperature of a cell of battery pack, lower a temperature of the flowing fluid, maintain the entire battery pack below a target temperature, raise the temperature of a cold spot location in the battery pack, raise the temperature of a cell of battery pack, raise a temperature of the fluid, maintain the entire battery pack above a target temperature, and maintain the battery pack within a battery pack temperature gradient.

In some embodiments, the optimal flow direction is chosen from the first flow direction and the second flow direction. In some embodiments, the optimal flow direction is chosen from the first flow direction, the second flow direction, and a third flow direction. In some embodiments, the optimal flow direction is chosen from the first flow direction, the second flow direction, a third flow direction, and a fourth flow direction.

In some embodiments, the optimal flow direction is the flow direction that will lower the temperature of a hot spot location in the battery pack. The hot spot may be a predicted hot spot based on the current flow direction, and/or based on the combination of the current flow direction and a previous flow direction, and/or based on a combination of recent flow directions (which may or may not include the current flow direction and, at least, the flow direction previous to the current flow direction). The hot spot may be a location of a predicted hot location in the battery pack based on a previous flow direction. The hot spot may be the location of a measured temperature of the battery pack (or a portion thereof). The hot spot may be a location of a measured temperature of the plate (or a portion thereof). The hot spot may be a location of a measured temperature of the fluid. The hot spot may be any combination of predicted and actual temperature readings. The hot spot may be any combination of actual temperature readings.

In some embodiments, the optimal flow direction is the flow direction that will raise the temperature of a cold spot location in the battery pack. The cold spot may be a predicted cold spot based on the current flow direction, and/or based on the combination of the current flow direction and a previous flow direction, and/or based on a combination of recent flow directions (which may or may not include the current flow direction and, at least, the flow direction previous to the current flow direction). The cold spot may be a location of a predicted cold location in the battery pack based on a previous flow direction. The cold spot may be the location of a measured temperature of the battery pack (or a portion thereof). The cold spot may be a location of a measured temperature of the plate (or a portion thereof). The cold spot may be a location of a measured temperature of the fluid. The cold spot may be any combination of predicted and actual temperature readings. The cold spot may be any combination of actual temperature readings.

In some embodiments, the optimal flow direction is the flow direction that will lower the temperature of a cell (and/or of cells) of battery pack. In some embodiments, the optimal flow direction is the flow direction that will lower a temperature of the flowing fluid. In some embodiments, the optimal flow direction is the flow direction that will maintain the entire battery pack below a target temperature, or maintain the battery pack within a battery pack temperature gradient. In some embodiments, the optimal flow direction is the flow direction that will raise the temperature of a cell (and/or of cells) of battery pack. In some embodiments, the optimal flow direction is the flow direction that will raise a temperature of the fluid. In some embodiments, the optimal flow direction is the flow direction that will maintain the entire battery pack above a target temperature, or maintain the battery pack within a battery pack temperature gradient.

Provided herein is a system for thermal management of a battery pack. The system may be used in an electric vehicle, a hybrid electric vehicle, or in another application that requires a battery pack. In some embodiments, the system comprises: a battery pack comprising a plurality of cells; an interstitial member between at least two cell of the plurality of cells; a first plate coupled to the interstitial member; a second plate coupled to interstitial member; and a flowing fluid capable of drawing heat generated by the battery pack from the interstitial member to the first plate and for drawing the heat generated by the battery pack from the interstitial member to the second plate, wherein the interstitial member comprises a thermally conductive material, and wherein the system is capable of flowing the flowing fluid in a first flow direction and in a second flow direction.

In some embodiments, the system is capable of flowing the flowing fluid in the first flow direction and in the second flow direction at the same time. In some embodiments, the system is capable of flowing the flowing fluid in the first flow direction and in the second flow direction at different times. In some embodiments, the first flow direction and the second flow direction are different directions. In some embodiments, the system comprises a control element that is capable of changing in the flow direction of the flowing fluid from the first flow direction to the second flow direction, and from the second flow direction to the first flow direction. In some embodiments, the system is capable of alternating the flow of the flowing fluid between the first flow direction and the second flow direction. In some embodiments, the system is capable of alternating the flow of the flowing fluid among a plurality of flow directions. In some embodiments, the system is capable of alternating the flow of the flowing fluid among the first flow direction, the second flow direction, and a third flow direction. In some embodiments, the system is capable of alternating the flow of the flowing fluid among the first flow direction, the second flow direction, a third flow direction, and a fourth flow direction. In some embodiments, the thermal management cools the battery pack. In some embodiments, the thermal management heats the battery pack. In some embodiments, the thermal management cools at least one cell of the battery pack, and heats at least one cell of the battery pack.

In some embodiments, changing the flow direction is in response to at least one of a predetermined time interval, the flowing fluid reaching a predetermined temperature, the flowing fluid reaching a predetermined temperature in one of a plurality of predetermined locations, a temperature of at least one cell in the battery pack, a cold spot location in the battery pack, and a hot spot location in the battery pack. In some embodiments, the predetermined temperature is at least one of about 1 C (degrees Celsius), about 5 C, about 10 C, about 20 C, about 25 C, about'30 C, about 35 C, about 40 C, about 45 C, about 50 C, about 55 C, about 60 C, about 65 C, about 70 C, about 75 C, about 80 C, about 85 C, about 90 C, about 95 C, and about 100 C. In some embodiments, the target temperature range (or temperature range) is at least one of: about 1 C to about 5 C, about 1 C to about 10 C, about 1 C to about 30 C, about 10 C to about 20 C, about 10 C to about 30 C, about 25 C to about 50 C, about 20 C to about 30 C, about 30 C to about 40 C, about 40 C to about 50 C, about 50 C to about 60 C, about 60 C to about 70 C, about 70 C to about 80 C, about 80 C to about 90 C, about 90 C to about 100 C, about 25 C to about 75 C, about 30 C to about 60 C, about 40 C to about 60 C, about 50 C to about 100 C, about 50 C to about 75 C, about 60 C to about 80 C, about 75 C to about 100 C, about 75 C to about 90 C, about 80 C to about 100 C, about 75 C to about 80 C, about 20 to about 25 C, about 25 C to about 30 C, about 30 C to about 35 C, about 35 C to about 40 C, about 40 C to about 45 C, about 45 C to about 50 C, about 50 C to about 55 C, about 55 C to about 60 C, about 60 C to about 65 C, about 65 C to about 70 C, about 70 C to about 75 C, about 75 C to about 80 C, about 80 C to about 85 C, about 85 C to about 90 C, about 90 C to about 95 C, and about 95 C to about 100 C. As used herein, the term “about” is meant as a range of at least one of: 1 C, 2 C, 5 C, 10%, 15%, and 25%. In some embodiments, the predetermined temperature is chosen based upon the cell type (materials, composition, size, shape), pack design (i.e. number of cells, locations and arrangements of cells, locations, materials, and/or configurations of the interstitial members and/or plates), fluid flow capabilities (e.g. multiple flow directions possible, flow along multiple plates, simultaneous multi-directional flow), and/or temperature and/or composition of the fluid, for non-limiting example.

In some embodiments, the plate (or plates) create thermal homogeneity of the battery pack. In some embodiments, the plate (or plates) use regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the control element is capable of changing among the first flow direction, the second flow direction and the third flow direction in response to at least one of a predetermined time interval, the flowing fluid reaching a predetermined temperature, the flowing fluid reaching a predetermined temperature in one of a plurality of predetermined locations, a temperature of at least one cell in the battery pack, a cold spot location in the battery pack, and a hot spot location in the battery pack In some embodiments, the predetermined temperature is at least one of about 1 C (degrees Celsius), about 5 C, about 10 C, about 20 C, about 25 C, about 30 C, about 35 C, about 40 C, about 45 C, about 50 C, about 55 C, about 60 C, about 65 C, about 70 C, about 75 C, about 80 C, about 85 C, about 90 C, about 95 C, and about 100 C. In some embodiments, the target temperature range (or temperature range) is at least one of about 1 C to about 5 C, about 1 C to about 10 C, about 1 C to about 30 C, about 10 C to about 20 C, about 10 C to about 30 C, about 25 C to about 50 C, about 20 C to about 30 C, about 30 C to about 40 C, about 40 C to about 50 C, about 50 C to about 60 C, about 60 C to about 70 C, about 70 C to about 80 C, about 80 C to about 90 C, about 90 C to about 100 C, about 25 C to about 75 C, about 30 C to about 60 C, about 40 C to about 60 C, about 50 C to about 100 C, about 50 C to about 75 C, about 60 C to about 80 C, about 75 C to about 100 C, about 75 C to about 90 C, about 80 C to about 100 C, about 75 C to about 80 C, about 20 to about 25 C, about 25 C to about 30 C, about 30 C to about 35 C, about 35 C to about 40 C, about 40 C to about 45 C, about 45 C to about 50 C, about 50 C to about 55 C, about 55 C to about 60 C, about 60 C to about 65 C, about 65 C to about 70 C, about 70 C to about 75 C, about 75 C to about 80 C, about 80 C to about 85 C, about 85 C to about 90 C, about 90 C to about 95 C, and about 95 C to about 100 C. As used herein, the term “about” is meant as a range of at least one of: 1 C, 2 C, 5 C, 10%, 15%, and 25%. In some embodiments, the predetermined temperature is chosen based upon the cell type (materials, composition, size, shape), pack design (i.e. number of cells, locations and arrangements of cells, locations, materials, and/or configurations of the interstitial members and/or plates), fluid flow capabilities (e.g. multiple flow directions possible, flow along multiple plates, simultaneous multi-directional flow), and/or temperature and/or composition of the fluid, for non-limiting example.

In some embodiments, the plate (or plates) create thermal homogeneity of the battery pack. In some embodiments, the plate (or plates) use regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

Some embodiments of the system provided herein comprise a control element capable of changing among the first flow direction, the second flow direction, a third flow direction, and a fourth flow direction in response to at least one of: a predetermined time interval, the flowing fluid reaching a predetermined temperature, the flowing fluid reaching a predetermined temperature in one of a plurality of predetermined locations, a temperature of at least one cell in the battery pack, a cold spot location in the battery pack, and a hot spot location in the battery pack.

In some embodiments, the control element is capable of applying the flowing fluid to the battery pack in an optimal flow direction. In some embodiments, the optimal flow direction is chosen from the first flow direction and the second flow direction. In some embodiments, the optimal flow direction is chosen from the first flow direction, the second flow direction, and a third flow direction. In some embodiments, the optimal flow direction is chosen from the first flow direction, the second flow direction, a third flow direction, and a fourth flow direction. In some embodiments, the predetermined temperature is at least one of about 1 C (degrees Celsius), about 5 C, about 10 C, about 20 C, about 25 C, about 30 C, about 35 C, about 40 C, about 45 C, about 50 C, about 55 C, about 60 C, about 65 C, about 70 C, about 75 C, about 80 C, about 85 C, about 90 C, about 95 C, and about 100 C. In some embodiments, the target temperature range (or temperature range) is at least one of: about 1 C to about 5 C, about 1 C to about 10 C, about 1 C to about 30 C, about 10 C to about 20 C, about 10 C to about 30 C, about 25 C to about 50 C, about 20 C to about 30 C, about 30 C to about 40 C, about 40 C to about 50 C, about 50 C to about 60 C, about 60 C to about 70 C, about 70 C to about 80 C, about 80 C to about 90 C, about 90 C to about 100 C, about 25 C to about 75 C, about 30 C to about 60 C, about 40 C to about 60 C, about 50 C to about 100 C, about 50 C to about 75 C, about 60 C to about 80 C, about 75 C to about 100 C, about 75 C to about 90 C, about 80 C to about 100 C, about 75 C to about 80 C, about 20 to about 25 C, about 25 C to about 30 C, about 30 C to about 35 C, about 35 C to about 40 C, about 40 C to about 45 C, about 45 C to about 50 C, about 50 C to about 55 C, about 55 C to about 60 C, about 60 C to about 65 C, about 65 C to about 70 C, about 70 C to about 75 C, about 75 C to about 80 C, about 80 C to about 85 C, about 85 C to about 90 C, about 90 C to about 95 C, and about 95 C to about 100 C. As used herein, the term “about” is meant as a range of at least one of: 1 C, 2 C, 5 C, 10%, 15%, and 25%. In some embodiments, the predetermined temperature is chosen based upon the cell type (materials, composition, size, shape), pack design (i.e. number of cells, locations and arrangements of cells, locations, materials, and/or configurations of the interstitial members and/or plates), fluid flow capabilities (e.g. multiple flow directions possible, flow along multiple plates, simultaneous multi-directional flow), and/or temperature and/or composition of the fluid, for non-limiting example. In some embodiments, the plate (or plates) create thermal homogeneity of the battery pack. In some embodiments, the plate (or plates) use regenerative heat exchange to create thermal homogeneity of the battery pack. In some embodiments, thermal homogeneity of the battery pack comprises a battery pack temperature gradient of at least one of: at most 1 degree Celsius, at most 2 degrees Celsius, at most 3 degrees Celsius, at most 5 degrees Celsius, at most 10 degrees Celsius, at most 15 degrees Celsius, at most 20 degrees Celsius, at most 25 degrees Celsius, at most 30 degrees Celsius, at most 35 degrees Celsius, at most 40 degrees Celsius, at most 45 degrees Celsius, at most 50 degrees Celsius, 0-20 degrees Celsius, 0-10 degrees Celsius, 0-5 degrees Celsius, 5-10 degrees Celsius, 5-20 degrees Celsius, 10-20 degrees Celsius, 10-30 degrees Celsius, 10-40 degrees Celsius, and 10-50 degrees Celsius. In some embodiments, the battery pack temperature gradient is the difference in temperature between the hottest location in the pack and the coolest location in the pack. In some embodiments, the hottest location and the coolest location in the pack are theoretically determined based on pack design (number and arrangement of cells, number and arrangement of plates) and fluid flow direction (or directions), at least.

In some embodiments, the optimal flow direction is the flow direction that will at least one of lower the temperature of a hot spot location in the battery pack, lower the temperature of a cell of battery pack, lower a temperature of the flowing fluid, and maintain the entire battery pack below a target temperature. In some embodiments, the optimal flow direction is the flow direction that will lower the temperature of a hot spot location in the battery pack. The hot spot may be a predicted hot spot based on the current flow direction, and/or based on the combination of the current flow direction and a previous flow direction, and/or based on a combination of recent flow directions (which may or may not include the current flow direction and, at least, the flow direction previous to the current flow direction). The hot spot may be a location of a predicted hot location in the battery pack based on a previous flow direction. The hot spot may be the location of a measured temperature of the battery pack (or a portion thereof). The hot spot may be a location of a measured temperature of the plate (or a portion thereof). The hot spot may be a location of a measured temperature of the fluid. The hot spot may be any combination of predicted and actual temperature readings. The hot spot may be any combination of actual temperature readings.

In some embodiments, the optimal flow direction is the flow direction that will raise the temperature of a cold spot location in the battery pack. The cold spot may be a predicted cold spot based on the current flow direction, and/or based on the combination of the current flow direction and a previous flow direction, and/or based on a combination of recent flow directions (which may or may not include the current flow direction and, at least, the flow direction previous to the current flow direction). The cold spot may be a location of a predicted cold location in the battery pack based on a previous flow direction. The cold spot may be the location of a measured temperature of the battery pack (or a portion thereof). The cold spot may be a location of a measured temperature of the plate (or a portion thereof). The cold spot may be a location of a measured temperature of the fluid. The cold spot may be any combination of predicted and actual temperature readings. The cold spot may be any combination of actual temperature readings.

In some embodiments, the optimal flow direction can change between at least the first flow direction and the second flow direction in order to: lower the temperature of a hot spot location in the battery pack, lower the temperature of a cell of battery pack, lower a temperature of the flowing fluid, and/or maintain the entire battery pack below a target temperature.

Provided herein is a method for thermal management of a battery pack comprising providing an interstitial member between cells of a battery pack, the interstitial member comprising a thermally conductive material and being coupled to at least one plate along which a fluid may flow in multiple directions sequentially to conductively cool cells of the battery pack. Provided herein is a method for thermal management of a battery pack comprising providing an interstitial member between cells of a battery pack, the interstitial member comprising a thermally conductive material and being coupled to at least one plate along which a fluid may flow in multiple directions simultaneously to conductively cool (or heat) cells of the battery pack. Provided herein is a method for thermal management of a battery pack comprising providing an interstitial member between cells of a battery pack, the interstitial member comprising a thermally conductive material and being coupled to at least one plate along which a fluid may flow in multiple directions concurrently to conductively cool (or heat) cells of the battery pack.

In some embodiments, the thermal management cools the battery pack. In some embodiments, the thermal management heats the battery pack. In some embodiments, the thermal management cools at least one cell of the battery pack, and heats at least one cell of the battery pack.

While an application of the systems and methods provided herein is for use in an electric vehicle, the systems and methods provided herein may also and/or alternatively be used in other applications requiring a battery pack (such as in a hybrid electric vehicle or another application).

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

What is claimed is:

1. A system for thermal management of a battery pack comprising:
the battery pack comprising a plurality of cells;
an interstitial member between at least two cell of the plurality of cells;
a first plate coupled to the interstitial member;
a second plate coupled to interstitial member; and
a flowing fluid capable of at least one of:
drawing heat generated by the battery pack from the interstitial member to the first plate and capable of drawing the heat generated by the battery pack from the interstitial member to the second plate, wherein the heat is drawn to the first plate in a different direction than the heat is drawn to the second plate,
and imparting heat from the fluid to the first plate to the interstitial member and to the battery pack and capable of imparting heat from the fluid to the second plate to the interstitial member and to the battery pack, wherein the heat is imparted from the first plate to the battery pack in a different direction than the heat imparted from the second plate to the battery pack,
wherein the interstitial member comprises a thermally conductive material.

2. The system of claim 1, wherein at least one of the first plate and the second plate comprises a plurality of layers of the thermally conductive material.

3. The system of claim 1, comprising a third plate coupled to the interstitial member.

4. The system of claim 1, wherein the interstitial member and at least one of the first plate and the second plate are contiguous.

5. A system for thermal management of a battery pack comprising:
the battery pack comprising a plurality of cells;
an interstitial member between at least two cell of the plurality of cells;
a first plate coupled to the interstitial member; and
a flowing fluid capable of at least one of:
drawing heat generated by the battery pack from the interstitial member to the first plate, and
imparting heat to the first plate to the interstitial member and to the battery pack,
wherein the interstitial member comprises a thermally conductive material, and wherein the flowing fluid changes from a first flow direction to a second flow direction.

6. The system of claim 5, wherein the first flow direction is the reverse direction of the second flow direction.

7. The system of claim 5, wherein the first flow direction is 90 degrees rotated from the second flow direction.

8. The system of claim 5, comprising a control element capable of changing the first flow direction to the second flow direction in response to at least one of:
a predetermined time interval,
the flowing fluid reaching a predetermined temperature,
the flowing fluid reaching a predetermined temperature in one of a plurality of predetermined locations,
a temperature of at least one cell in the battery pack,
a cold spot location in the battery pack, and
a hot spot location in the battery pack.

9. The system of claim 5, wherein the flowing fluid changes from the second flow direction to the first flow direction.

10. The system of claim 5, comprising a control element capable of applying the flowing fluid to the battery pack in an optimal flow direction.

11. The system of claim 10, wherein the optimal flow direction is the flow direction that will at least one of:
(a) lower the temperature of a hot spot location in the battery pack,
(b) raise the temperature of a cold spot location in the battery pack,
(c) lower the temperature of a cell of battery pack,
(d) lower a temperature of the flowing fluid,
(e) raise a temperature of the flowing fluid,
(f) maintain the entire battery pack below a target temperature,
(g) maintain the entire battery pack above a target temperature, and
(h) maintain the entire battery pack within at battery pack temperature gradient.

12. A system for thermal management of a battery pack comprising:
the battery pack comprising a plurality of cells;
an interstitial member between at least two cell of the plurality of cells;
a first plate coupled to the interstitial member;
a second plate coupled to interstitial member; and
a flowing fluid capable of at least one of:
drawing heat generated by the battery pack from the interstitial member to the first plate.
drawing the heat generated by the battery pack from the interstitial member to the second plate,
imparting heat from the flowing fluid to the first plate to the interstitial member and to the battery pack, and
imparting heat from the flowing fluid to the second plate to the interstitial member, and to the battery pack,
wherein the interstitial member comprises a thermally conductive material, and wherein the system is capable of flowing the flowing fluid in a first flow direction and in a second flow direction.

13. The system of claim 12, wherein the system comprises a control element that is capable of changing in the flow direction of the flowing fluid from the first flow direction to the second flow direction, and from the second flow direction to the first flow direction.

14. The system of claim 13, wherein changing the flow direction is in response to at least one of a predetermined time interval,
the flowing fluid reaching a predetermined temperature,
the flowing fluid reaching a predetermined temperature in one of a plurality of predetermined locations,
a temperature of at least one cell in the battery pack,
a cold spot location in the battery pack, and
a hot spot location in the battery pack.

15. The system of claim 13, wherein the control element is capable of applying the flowing fluid to the battery pack in an optimal flow direction.

16. A method for thermal management of a battery pack comprising:
providing the battery pack comprising a plurality of cells and an interstitial member between at least two cell of the plurality of cells;
providing a plurality of plates coupled to the interstitial member; and
providing a control element capable of flowing a fluid along the plurality of plates
wherein the control element is capable of at least one of:
drawing heat generated by the battery pack in a first direction from the interstitial member to a first plate of the plurality of plates and drawing heat generated by the battery pack in a second direction from the interstitial member to a second plate of the plurality of plates, and
imparting heat in a first direction from the fluid to a first plate of the plurality of plates, to the interstitial member, and to the battery pack, and imparting heat in a second direction from the fluid to a second plate of the plurality of plates, to the interstitial member, and to the battery pack,
wherein the interstitial member comprises a thermally conductive material, and wherein the first direction is a different direction than the second direction.

17. The method of claim 16, comprising providing the first plate adjacent a first surface of the battery pack, and providing the second plate adjacent a second surface of the battery pack.

18. The method of claim 16, wherein the interstitial member and at least one of the first plate and the second plate are contiguous.

19. A method for thermal management of a battery pack comprising:
providing the battery pack comprising a plurality of cells and an interstitial member comprising a thermally conductive material between at least two cells of the plurality of cells;
providing a first plate coupled to the interstitial member; and
providing a control element capable of at least one of
drawing heat generated by the battery pack from the interstitial member to the first plate by flowing a fluid along the first plate in a first flow direction, and flowing the fluid along the first plate in a second flow direction, and
imparting heat to the battery pack from the interstitial member by flowing a fluid along the first plate in a first flow direction, and flowing the fluid along the first plate in a second flow direction.

20. The method of claim 19, wherein the first plate is on multiple surfaces of the battery pack.

21. The method of claim 19, wherein the control element is capable of changing between the first flow direction and the second flow direction in response to at least one of a predetermined time interval,
the fluid reaching a predetermined temperature,
the fluid reaching a predetermined temperature at a predetermined location,
the fluid reaching a predetermined temperature at one of a plurality of predetermined locations,
a temperature of at least one cell in the battery pack,
a cold spot location in the battery pack, and
a hot spot location in the battery pack.

22. A method for thermal management of a battery pack comprising:
providing the battery pack comprising a plurality of cells and an interstitial member comprising a thermally conductive material between at least two cell of the plurality of cells;
providing a first plate coupled to the interstitial member, and
providing a control element capable of at least one of:
drawing heat generated by the battery pack from the interstitial member to the first plate by determining an optimal fluid flow direction, and flowing a fluid along the first plate in the optimal flow direction, and
imparting heat to the battery pack from the interstitial member by determining an optimal fluid flow direction, and flowing a fluid along the first plate in the optimal flow direction.

23. The method of claim 22, wherein determining an optimal fluid flow direction comprises determining which of a first flow direction and a second flow direction is the optimal flow direction.

24. The method of claim 22, wherein the optimal flow direction is the flow direction that will at least one of:
lower the temperature of a hot spot location in the battery pack,
lower the temperature of a cell of battery pack,
lower a temperature of the fluid,
raise the temperature of a cold spot location in the battery pack,
raise the temperature of a cell of the battery pack,
raise a temperature of the fluid,
maintain the battery pack within a temperature range,
maintain the entire battery pack above a target temperature, and
maintain the entire battery pack below a target temperature.
